(19) United States
(12) Patent Application Publication
(10) Pub. No.: US 2013/0138908 A1
(43) Pub. Date: May 30, 2013

(54) STORAGE SYSTEM AND POOL CAPACITY SCALE-DOWN CONTROL METHOD

(71) Applicant: Junji Iwasaki, Yokohama (JP)

(72) Inventor: Junji Iwasaki, Yokohama (JP)

(73) Assignee: Hitachi, Ltd.

(21) Appl. No.: 13/351,902

(22) Filed: Jan. 17, 2012

(30) Foreign Application Priority Data
Nov. 30, 2011 (JP) 2011-263042

(51) Int. Cl. G06F 12/02

(52) U.S. Cl. 711/165; 711/E12.002

(57) ABSTRACT

The present invention provides a storage system, which efficiently uses a storage system internal storage area related to an internal volume in a case where an internal volume and an external volume are allocated to a pool. The storage system comprises a controller which manages a pool to which an internal volume and an external volume are allocated, and upon receiving a write request, provides a virtual volume to which one or more real pages inside the pool are allocated. In a case where the storage capacity of the pool is to be reduced, the allocation to the pool of the external volume is preferentially canceled over the internal volume.

### CROSS-REFERENCE TO PRIOR APPLICATION

This application relates to and claims the benefit of priority from Japanese Patent Application number 2011-236042, filed on Nov. 30, 2011 the entire disclosure of which is incorporated herein by reference.

### BACKGROUND OF THE INVENTION

1. Field of the Invention

The present invention relates to capacity control in a pool comprising a real area, which is allocated to a virtual logical volume.

2. Description of the Related Art

Heretofore, a storage system, which comprises multiple types of storage devices each with different performance, has been known. This storage system treats an aggregate of storage areas on physical storage devices of the same type as one hierarchy (hereinafter, called a tier), and can manage data using a pool comprising multiple tiers. For example, in a case where the capacity of this pool is insufficient in a hierarchized storage system like this, scaling up the capacity of the pool by adding to the pool a storage area of an external storage system coupled to the storage system is known (Japanese Patent Application Laid-open No. 2007-213448). For example, the scaling up and the scaling down of the capacity of this pool in the storage system is also known (Japanese Patent Application Laid-open No. 2006-338341).

In the future, a mode in which a storage system is linked, for example, to a cloud provider (an online storage provider)-provided external storage apparatus, which the storage system maintains as its own resource and which is in the cloud, and in a case where the storage areas inside the storage system become depleted, uses a storage area of the external storage apparatus on the cloud is conceivable. The problem in this case is that since charges are incurred in accordance with the utilization amount and time when using a storage area of the external storage apparatus on the cloud, the storage areas inside the storage system must be used as efficiently as possible.

However, since neither a utilization mode such as this nor the above-mentioned problem is taken into account in Japanese Patent Application Laid-open No. 2007-213448 and Japanese Patent Application Laid-open No. 2006-338341, an apparatus and method for increasing the rate of utilization of the storage areas inside the storage system as compared to the rate of utilization of the storage areas in the external storage apparatus are not disclosed.

Furthermore, in Japanese Patent Application Laid-open No. 2007-213448 and Japanese Patent Application Laid-open No. 2006-338341, the fact that the pool is managed hierarchically, and that data is migrated between tiers in units of pages (a unit that is smaller than a volume) is also not disclosed. The problem is that when a certain tier in the pool comprises a storage area of the external storage and a migration is executed between tiers, the data must be migrated from the storage area of the external storage to an internal storage area of the storage system, placing a load on the network during this time.

Therefore, the problem is that in a case where the storage capacity inside the storage has become depleted, it is necessary to reduce the storage capacity of the external storage when resolving the depletion of the storage capacity inside the storage even when the storage capacity of the external storage is included in a certain tier of the pool temporarily.

### SUMMARY OF THE INVENTION

A storage system of the present invention for solving the above-mentioned problems is a storage system comprising a controller, which manages multiple storage devices, multiple internal volumes associated with the multiple storage devices, and multiple external volumes associated with multiple external storage devices included in an external storage system, manages a first pool to which at least one internal volume included in the multiple internal volumes and at least one external volume included in the multiple external volumes are allocated, and, in a case where a write request has been received, provides a first virtual volume to which one or more real pages inside the first pool are allocated, and in a case where a storage capacity of the first pool is to be reduced, the controller preferentially cancels the allocation to the first pool of an external volume included in the at least one external volume over the at least one internal volume.

A control method of the present invention for solving the above-mentioned problems is a control method in a storage system which comprises multiple storage devices, the control method including managing multiple internal volumes associated with the multiple storage devices, and multiple external volumes associated with multiple external storage devices included in an external storage system, managing a first pool to which at least one internal volume included in the multiple internal volumes and at least one external volume included in the multiple external volumes are allocated, and providing a first virtual volume to which one or more real pages inside the first pool are allocated in a case where a write request has been received, and preferentially canceling the allocation to the first pool of an external volume included in the at least one external volume over the at least one internal volume in a case where a storage capacity of the first pool is to be reduced.

When downscaling a certain tier in a pool comprising an internal storage area of a storage apparatus and a storage area of an external storage apparatus, the present invention has the effect of making it possible to efficiently use a storage area inside the storage apparatus by preferentially deleting a storage area of the external storage apparatus.

### BRIEF DESCRIPTION OF THE DRAWINGS

FIG. 1 is a diagram illustrating an overview of Example 1;

FIG. 2 is a diagram showing an example of a computer system 100 related to Example 1;

FIG. 3 is a diagram showing an example of logical volumes formed on the basis of PDEVs;

FIG. 4A shows examples of tables stored in a control memory 014. FIG. 4B shows an example of a table stored in a control memory 114;

FIG. 5 shows an example of a pool management table 042;

FIG. 6 shows an example of a VVOL management table 043.

FIG. 7 shows an example of a VOL management table (1) 044;

FIG. 8 shows an example of an external use determination table 045;

FIG. 9 shows an example of a VOL management table (2) 046;

FIG. 10A shows an example of the configuration of a VOL management table 049(A) stored in the control memory 114 of an external storage #1. FIG. 10B shows an example of the configuration of a VOL management table 049(B) stored in the control memory 114 of an external storage #2;

FIG. 11 shows an example of a tier definition table;

FIG. 12 is a portion of an example of a flowchart of a tier determination process;

FIG. 13 is the remainder of the example of the flowchart of the tier determination process;

FIG. 14 is an example of a flowchart of a data write process;

FIG. 15 is an example of a flowchart of a data read process;

FIG. 16 is an example of a flowchart of a dynamic tiering process;

FIG. 17 is an example of a flowchart of a pool capacity scale-up process;

FIG. 18 is a diagram illustrating an overview of a pool scale-down process of Example 1;

FIG. 19 is an example of a flowchart of the pool capacity scale-down process of Example 1;

FIG. 20 is a diagram illustrating an overview of a pool scale-down process of Example 2;

FIG. 21 is a first part of an example of a flowchart of the pool capacity scale-down process of Example 2;

FIG. 22 is a second part of the example of the flowchart of the pool capacity scale-down process of Example 2;

FIG. 23 is a diagram illustrating an overview of a pool scale-down process of Example 3;

FIG. 24 is a first part of an example of a flowchart of the pool capacity scale-down process of Example 3; and

FIG. 25 is remainder of the example of the flowchart of the pool capacity scale-down process of Example 3.

### DETAILED DESCRIPTION OF THE EMBODIMENTS

A number of examples will be explained below.

Furthermore, in the following explanation, various types of information may be explained using the expression “xxx table”, but the various information may also be expressed using a data structure other than a table. To show that the various information is not dependent on the data structure, “xxx table” can be called “xxx information”.

Also, in the following explanation, there may be cases where processing is explained having a “program” as the doer of the action, but since the stipulated processing is performed in accordance with a program being executed by a processor (for example, a CPU (Central Processing Unit)) of a controller while using a storage resource (for example, a memory) and/or a communication interface device (for example, a host adapter, a port, or a network adapter) as needed, the controller or the processor may also be used as the doer of the processing. A process, which is explained having the program as the doer of the action, may be a process performed by a storage system (or an external storage system), a management apparatus, or a host computer. A computer program may be installed in the controller or a computer from a program source. The program source, for example, may be either a program delivery server or a storage medium.

Furthermore, in the following explanation, in a case where a distinction is made when describing the same element, the element identification number may be used either instead of or in addition to the element reference sign.

A “PDEV (Physical Device)” is a physical storage device. The storage system (or the external storage system) may comprise, as the PDEV, at least one of a memory drive (for example, a SSD (Solid State Drive) comprising a nonvolatile semiconductor memory (for example, a flash memory), a HDD (Hard Disk Drive), and another type of drive. For at least one type of drive of the memory drive, the HDD, and the other type of drive (for example, a DVD drive), there may be multiple drives, which have different types of interfaces. The interface type may be at least one of FC (Fiber Channel), SAS (Serial Attached SCSI), or SATA (Serial ATA).

### Example 1

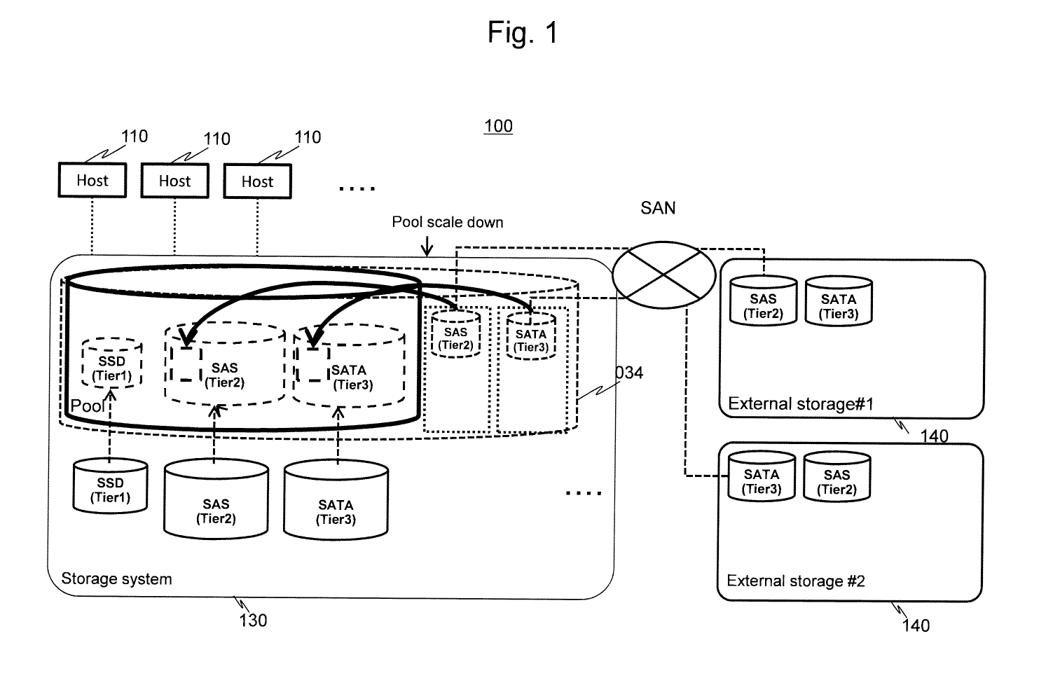

FIG. 1 is a diagram illustrating an overview of Example 1.

This example relates to technology for scaling down a pool of a storage system comprising the thin provisioning function. For example, the capacity of the pool is scaled down from the capacity denoted by the broken lines to the capacity denoted by the solid lines.

The pool 034 comprises either one or multiple logical volumes (hereinafter, VOL) (Hereinafter, a VOL, which is a component of the pool 034, will be called a “pool VOL”). A pool VOL may be the following (a) and (b):

(a) A VOL related to a storage area of one or more PDEVs (Physical Devices) in the storage system 130 (for example, a RAID (Redundant Array of Independent (or Inexpensive) Disks) group) (hereinafter, may be called IVOL (Internal Volume); or
(b) A virtual VOL related to a storage resource of an external storage system 140 (hereinafter, external storage) coupled to the storage system 130 (for example, a VOL conforming to storage virtualization technology, which carries out virtualization such that a virtual VOL to which an external VOL, which is a VOL of the external storage, is mapped, itself provides a storage area of the external storage system, which hereinafter may be called EVOL (External Volume)). Access to the EVOL is actually generated to the external VOL mapped to the EVOL.

The pool 034 is partitioned into multiple tiers. The height of a tier depends on access performance (I/O (Input/Output) performance). VOLs having about the same access performance belong to the same tier. The access performance of a VOL is basically determined by the performance of the PDEV constituting the basis of the VOL. The access performance of an EVOL depends on the I/O performance of the PDEV, which is the basis of the external VOL mapped to the EVOL, and the communication speed between the storage system 130 and the external storage 140. There may also be cases in which the access performance of the EVOL is dependent on an element other than these elements (for example, the performance of the external storage device apparatus controller). A pool may also comprise only one tier.

In thin provisioning, a real page is allocated to a virtual page in accordance with a write process, but alternatively, a reclamation process, which cancels the allocation of a real page to a virtual page in accordance with a data deletion or the like, can also be executed. Therefore, there may be cases in which, even though the used capacity of a storage area in the pool 034 has been increased temporarily, the used capacity is decreased in accordance with continued operation. In this case, it is necessary to cancel (also called delete) the allocation of the pool VOL allocated to the relevant pool, and scale down the pool.

The pool 034 can also have a pool VOL with a small used capacity (that is, the amount of stored data is small). In a case like this, data in the pool VOL having the relatively small used capacity is migrated to a different pool VOL, which has a relatively large used capacity, thereby making it possible to remove the small used capacity pool VOL from the pool, enabling the pool capacity to be scaled down as a result. The selection of a pool VOL with a relatively small used capacity as the migration-source pool VOL is done because a small amount of data is migrated, making it possible to reduce the data migration load.

The selection of the migration-source pool VOL and the migration-destination pool VOL is important when migrating data during pool downscaling.

In this example, as for the migration-source pool VOL, in a case where an EVOL, for which a storage area of the external storage system 140 is allocated to a VOL in the storage system 130, exists in the tier to be downscaled, the EVOL is preferentially deleted. This makes it possible to use the storage areas in the storage system 130 efficiently.

In this example, a pool VOL belonging to the same tier in the same pool as the migration-source pool VOL is selected as the migration-destination pool VOL. Therefore, it is possible to prevent important data (for example, data having a high average I/O frequency) from being migrated from a migration-source VOL to a pool VOL belonging to a low tier, and unimportant data (for example, data having a low average I/O frequency) from being migrated from a migration-source VOL to a pool VOL belonging to a high tier.

As an example, the present invention can be applied to a system such that the storage system 130 can access the external storage 140, which exists on the cloud, via a network, and temporarily use a storage area in the external storage system.

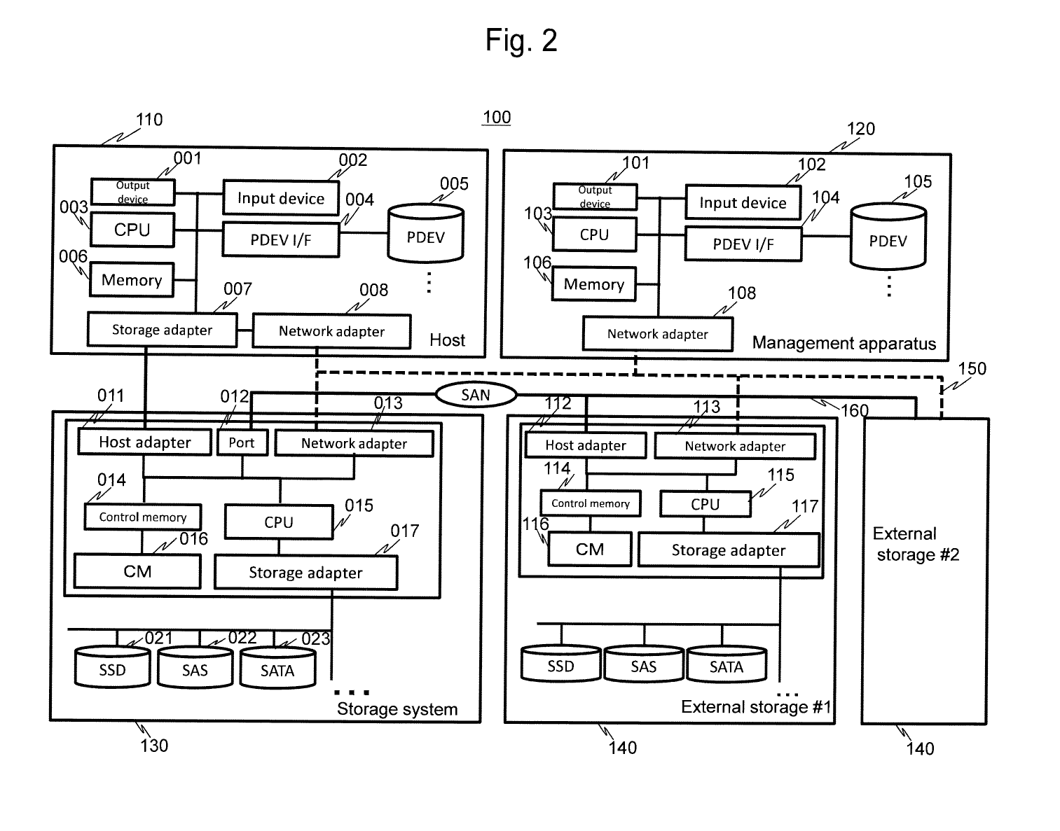

FIG. 2 is a diagram showing an example of the configuration of a computer system 100 related to Example 1.

The computer system 100 comprises a host computer (hereinafter, called a host) 110, a management apparatus 120, a storage system 130, and an external storage 140. These components are mutually coupled via a communication network 150. The communication network 150, for example, is an IP protocol-based network such as a LAN (Local Area Network), but the present invention is not limited to this.

The storage system 130 is coupled to the external storage 140 via a communication network 160. The communication network 160, for example, is a SAN (Storage Area Network), and is based on a protocol such as the iSCSI (Internet Small Computer System Interface) protocol or the FC (Fibre Channel) protocol, but the present invention is not limited to this.

The host 110 comprises an output device (for example, a display device) 001, an input device (for example, a keyboard or pointing device) 002, a CPU 003, a PDEV (for example, an auxiliary storage device) 005, a physical disk interface 004, and a memory (for example, a main memory device and a nonvolatile memory) 006. Since the host 110 is linked via networks to the storage system 130 and the external storage 140, it also comprises a storage adapter 007, which is coupled to a host adapter 011 of the storage system 130, and a network adapter 008, which is coupled to a network adapter 013 of the storage system 130 and the external storage 140, and a network adapter 108 of the management apparatus 120.

The management apparatus 120 comprises elements 101 through 106 and 108, which are the same elements as the elements 001 through 006 and 008 of the host 110. The management apparatus 120 need not comprise a network adapter.

The storage system 130 comprises multiple PDEVs 021 through 023, and a controller, which is coupled to these multiple PDEVs 021 through 023. The controller, for example, comprises a host adapter 011 (for example, a FC connection, a SCSI connection, or a CIFS/NFS connection) for coupling to the host 110, a port 012 (for example, a FC connection, a SCSI connection, or a CIFS/NFS connection) for coupling to the external storage 140, a network adapter 013 (for example, a network connection) for coupling to the host 110, the management apparatus 120 and the external storage 140, a control memory 014 (for example, either a volatile or an nonvolatile memory), a cache memory 016, a storage adapter 017 for coupling to the PDEVs 021 through 023, and a CPU 015, which is coupled to these components. Data being written to a VOL or data read from a VOL is temporarily stored in the cache memory 016.

The PDEVs 021 through 023 are multiple types of PDEVs with different access performance. In the example shown in the drawing, an SSD 021, a SAS drive (an SAS-interface HDD) 022, and a SATA drive (a SATA-interface HDD) 023 are in descending order according to access performance. However, the present invention is not limited to this, and the PDEV may also be a tape or other such storage medium.

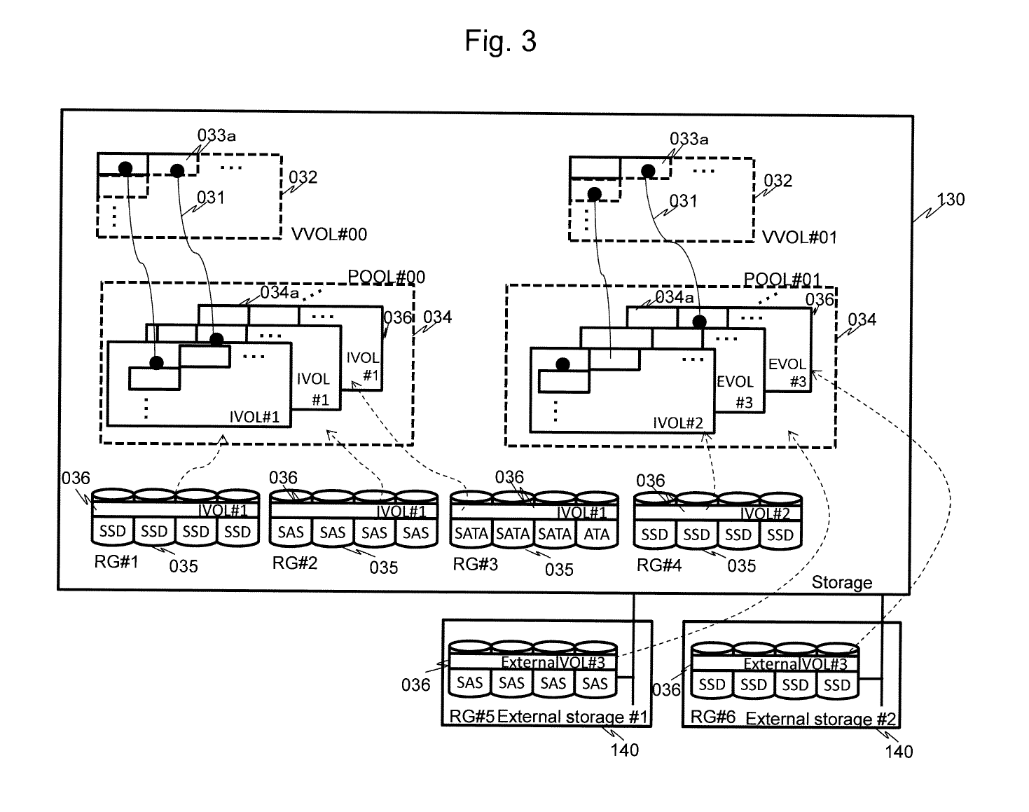

The external storage 140 comprises multiple PDEVs, and a controller coupled thereto the same as the storage system 130. The controller comprises elements 112 through 117, which are the same as the elements 012 through 017 of the storage system controller. FIG. 3 is a diagram showing an example of the corresponding relationships of the storage areas.

For example, one or more RAID (Redundant Array of Independent (or Inexpensive) Disks) groups 035 are configured from multiple PDEVs of the same type in the storage system 130. As shown in FIG. 1, in this example, since the PDEVs are a SSD, a SAS drive, and a SATA drive, the RAID groups include a RAID group comprising SSDs, a RAID group comprising SAS drives, and a RAID group comprising SATA drives. The RAID group 035, for example, stores data in accordance with a prescribed RAID level, such as RAID 1 or RAID 5.

One or more VOLs are formed on the basis of the RAID group. Specifically, a VOL 036 comprises the respective storage areas of the multiple PDEVs included in the RAID groups 035. In the example shown in the drawing, one VOL 036 is formed on the basis of one RAID group 035. However, the present invention is not limited to this, and multiple VOLs 036 may be formed from a single RAID group.

The pool 034 comprises multiple real areas allocatable to a VVOL 032. The real area is one part of the pool VOL 036 obtained by partitioning the pool VOL 036 in two or more segments. The real area is based on multiple PDEVs comprising a RAID group. Here, pool #00 comprises only one IVOL #1. Pool #00 is configured here so as to be unable to use an EVOL.

Alternatively, pool #01 comprises IVOL #2 and EVOL #3. Pool #01 is configured here so as to be able to use an EVOL.

The pool 034 may comprise VOLs 036 with different access performance. That is, the pool 034 is partitioned into multiple tiers. Each tier may comprise VOLs 036 with around the same access performance. The access performance of a VOL 036 is basically determined by the access performance of the PDEV(s) constituting the basis of the VOL 036, but the access performance of an EVOL may be determined by the access performance of the PDEV(s) constituting the basis of the external VOL mapped to the EVOL, and the connection environment of the storage system 130 and the external storage 140.

The VVOL (Virtual Volume) 032 is a virtual VOL provided to the host 110, and is a VOL comprising multiple virtual storage areas (hereinafter, “storage areas”). In a case where a write request is generated with respect to the VVOL 032, a real area in the pool 034 is allocated to the virtual area to which an address specified as the write destination in the write request belongs, and write-target data conforming to the write request is stored in this allocated real area. For this reason, in accordance with the VVOL 032 being provided to the host 110, it becomes possible to provide the host 110 with a larger storage capacity than the actual capacity. The allocation of the real area to the virtual area is performed in units of a prescribed size. In the following explanation, this allocation unit is called a “page” for the sake of convenience. Furthermore, a virtual area can be called a “virtual page”, and a real area can be called a “real page”. However, the real area allocation unit of the virtual area is not limited to the page, and may be a unit obtained by collecting together multiple pages.

Based on the above, the following can also be said. That is, the VVOL 032 is a logical volume comprising multiple virtual pages 033a. The pool 034 comprises one or more, and, in addition, one or more types of VOLs 036, and is a single real page group comprising multiple real pages 034a.

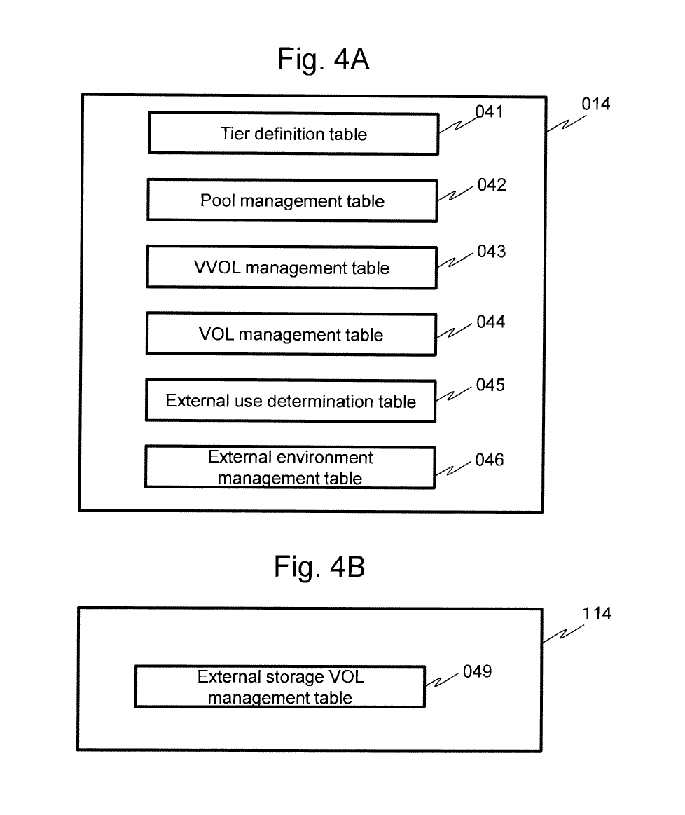

FIG. 4A shows an example of the configuration of tables stored in the control memory 014 of the storage system 130. FIG. 4B shows an example of the configuration of a table stored in the control memory 114 of the external storage 014.

The tables stored by the control memory 014, for example, are a tier definition table 041, a pool management table 042, a VVOL management table 043, a VOL management table (1) 044, an external use determination table 045, and a VOL management table (2) 046. The control memory 014 may also comprise a VOL management table 047 of the external storage 140.

The table stored by the control memory 114, for example, is the VOL management table 047 of the external storage.

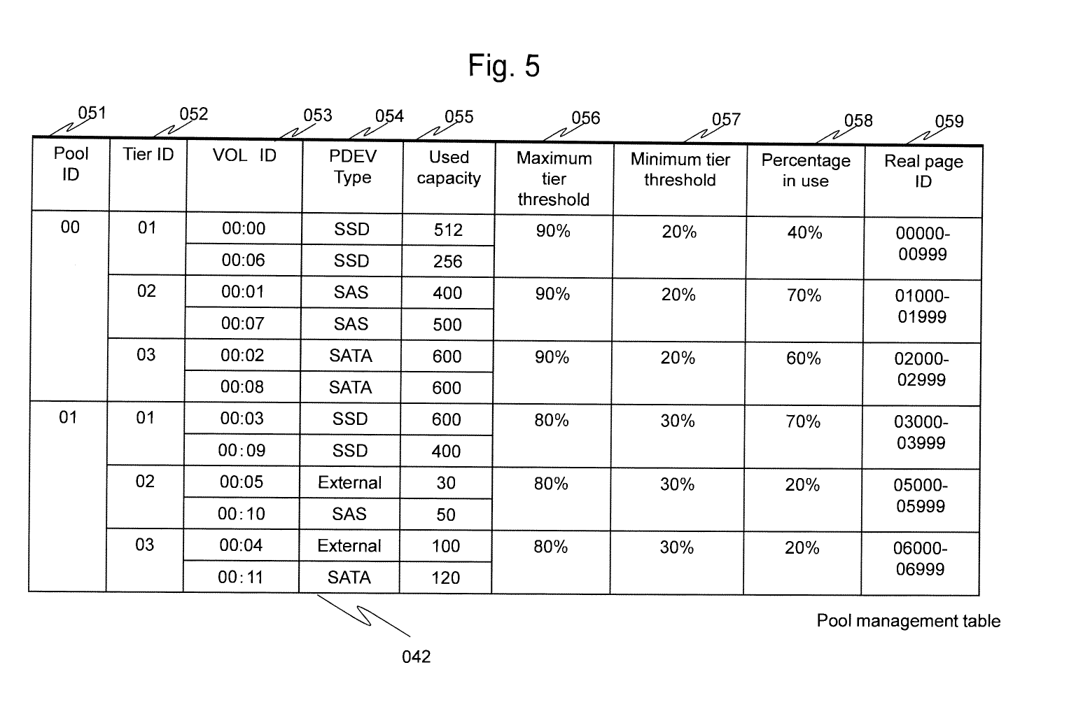

FIG. 5 shows an example of the configuration of the pool management table 042.

The pool management table 042 is a table, which shows the configuration of each pool 034. Specifically, for example, this table 042 comprises the following information for each pool VOL 036:

a pool ID 051 of a pool 034 comprising a pool VOL 036;

a tier ID 052 of the tier to which the pool VOL 036 belongs;

a VOL ID 053, which is the identification number of the pool VOL 036;

a PDEV type 054 denoting the type of multiple PDEVs, which constitute the basis of the pool VOL 036;

a used capacity 055 denoting the used capacity of the capacity of the pool VOL 036;

a maximum tier threshold 056 configured as the maximum value of the used percentage of the tier to which the pool VOL 036 belongs;

a minimum tier threshold 057 configured as the minimum value of the used percentage of the tier to which the pool VOL 036 belongs;

a current used percentage 058 of the tier to which the pool VOL 036 belongs; and

a real page ID 059 for all the real pages 034a belonging to the tier to which the pool VOL 036 belongs. The used capacity of the pool VOL 036 is the total of the capacities of the real pages 034a allocated to the virtual page 033a of the multiple real pages 034a belonging to this pool VOL 036. The used percentage of the tier is the percentage of total used capacity 055 of all the pool VOLs 036 belonging to the tier relative to the total capacity of all the real pages 034a belonging to the tier (to include a real page 034a that is not allocated to a virtual page 033a). That is, the used percentage of the tier is the percentage of the total capacity of the real pages allocated to the virtual pages 033a belonging to the tier relative to the total capacity of all the real pages 034a belonging to the tier (to include a real page 034a not allocated to a virtual page 033a).

Specifically, for example, pool VOL “00:00” is of the type “SSD” (that is, it is a VOL based on a SSD), and belongs to tier “01” of pool “00”. The tier “01” of pool “00” comprises real pages “00000” through “00999”, and the current used percentage is 40%. The maximum threshold of this tier is configured to 90%, and the minimum threshold is configured to 20%.

The maximum threshold and the minimum threshold, for example, may be configured from the management apparatus 120. In a case where the used capacity reaches the maximum threshold, either an addition or scale-up of tiers (that is, a pool 034 scale-up) is executed. In a case where the used capacity reaches the minimum threshold, either a deletion or scale-down of tiers (that is, a pool 034 scale-down) is executed.

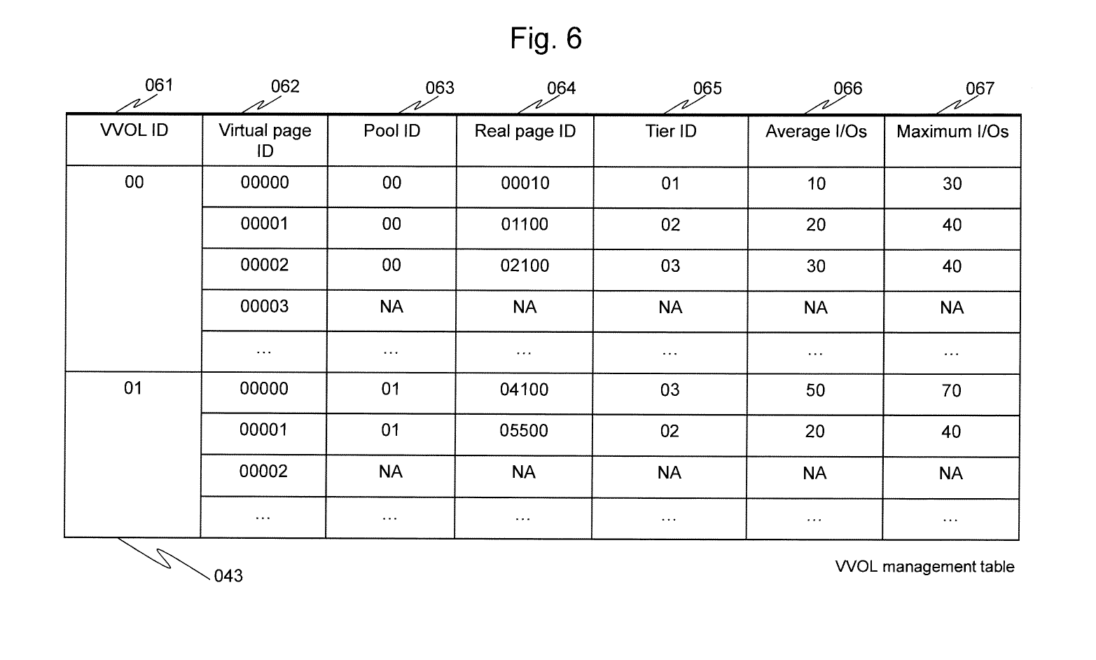

FIG. 6 shows the configuration of the VVOL management table 043.

The VVOL management table 043 shows the configuration of a VVOL 032. Specifically, for example, this table 043 comprises the following information for each virtual page 033a:

a VVOL ID 061 of the VVOL to which a virtual page belongs;

a virtual page ID 062, which is the identification number of the virtual page;

a POOL ID 063 of the pool 034 comprising the real page allocated to the virtual page;

a real page ID 064 of the real page allocated to the virtual page;

a tier ID 065 of the tier to which the real page allocated to the virtual page belongs;

an average I/Os 066, which is the average of the amount of data read and/or written per unit of time (for example, one second) from the host to the virtual page; and

a maximum I/Os 067, which is the maximum value of the data read and/or written per unit of time (for example, one second) from the host to the virtual page.

Specifically, for example, real page “00010” of tier “01” of pool “00” is allocated to virtual page “00000” belonging to VVOL “00”. The average amount of data read/written from/to the virtual page “00000” in a unit of time from the host is “10” MB per unit of time, and the maximum read/write amount is “30” MB.

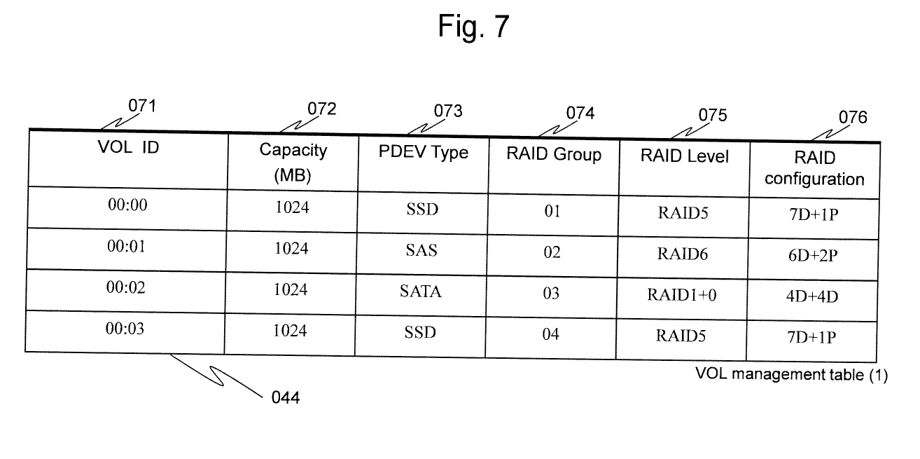

FIG. 7 shows an example of the configuration of the VOL management table (1) 044.

The VOL management table (1) 044 shows the configuration of each VOL 036. The VOL management table (1) 044 manages an IVOL configured by PDEV(s) in the storage system 130. Specifically, for example, this table 044 comprises the following information for each VOL 036:

a VOL ID 071, which is the identification number of a VOL 036;

a capacity 072 denoting the capacity of the VOL 036;

a PDEV Type 073 denoting the type of the multiple PDEVs, which constitute the basis of the VOL 036;

a RAID group 074 denoting the RAID group 035 comprising the multiple PDEVs, which constitute the basis of the VOL 036;

a RAID level 075 denoting the level of the RAID group 035; and

a RAID configuration 076 denoting the configuration of the RAID group 035.

Specifically, for example, the capacity of VOL “00:00” is 1024 MB. The VOL “00:00” is based on RAID group “01”, which comprises multiple PDEVs of disk type “SSD”. The RAID group “01” comprises seven data disks and one parity disk (7D+1P), and is RAID 5.

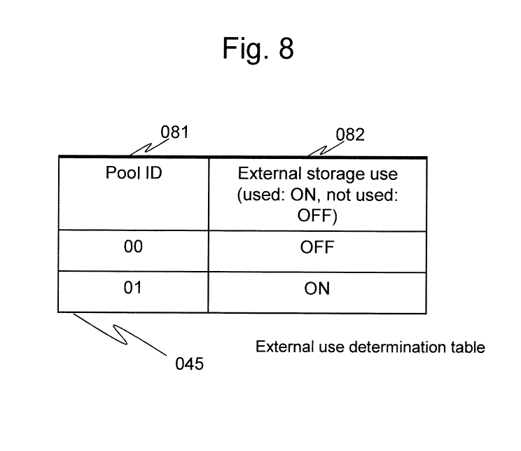

FIG. 8 shows an example of the configuration of the external use determination table 045.

The external use determination table 045 shows whether or not each pool 034 is able to use the external storage 140. Specifically, for example, this table 045 comprises the following information for each pool:

a pool ID 081, which is the identification number of a pool 034; and

an external storage use 082 denoting whether or not the pool 034 is able to use the external storage 140.

Specifically, for example, pool “00” is unable to use the external storage 140 (OFF), and pool “01” is able to use the external storage 140 (ON). The setting for this external storage use may be configured from the management apparatus 120.

For example, in the case of a VVOL for storing data, which is highly important data (customer data and so forth) and is not desirable for storing in a storage area of an external storage on the cloud, the external storage use is configured to “OFF”. In the case of a VVOL for storing data, which is of low importance and can be stored in a storage area of an external storage on the cloud, the external storage use is configured to “ON”.

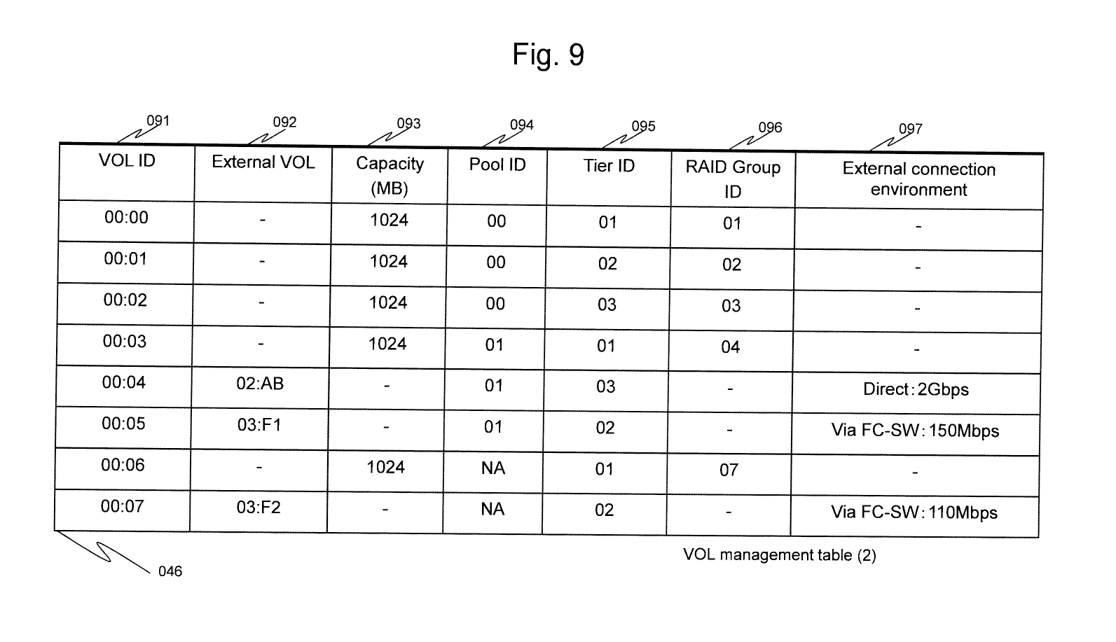

FIG. 9 shows an example of the configuration of the VOL management table (2) 046.

The VOL management table (2) 046 specifies whether or not there is a VOL (EVOL), which is mapped to an external VOL, and in a case where a VOL is an EVOL, specifies the connection environment between the storage system 130 and the external storage 140 for each VOL 036. Specifically, for example, this table 046 comprises the following information for each VOL 036:

a VOL ID 091, which is the identification number of a VOL 036;

an external VOL ID 092, which is the identification number of the external VOL corresponding to the VOL 036;

a capacity 093 of the VOL 036;

a POOL ID 094 of the pool 034 comprising the VOL 036;

a tier ID 095 of the tier to which the VOL 036 belongs;

a RAID group ID 096, which is the identification number of the RAID group 035, which constitutes the basis of the VOL 036; and

an external connection environment 097 denoting the connection environment between the storage system 130 and the external storage 140, and the transfer speed between the EVOL 036 and the external VOL 036.

Specifically, for example, VOL “00:00” is 1024 MB and is included in pool “00”. The VOL “00:00” belongs to tier “01”, is a logical device based on RAID group “01”, and is not an EVOL (is an IVOL). For example, VOL “00:04” is 1024 MB and is included in pool “01”. VOL “00:04” belongs to tier “03”, and is a logical device (an EVOL) based on external VOL “02:AB”. The external storage 140 comprising the external VOL “02:AB” is directly coupled to the storage system 130 at this time, and the transfer speed between the EVOL “00:04” and the external VOL “02:AB” is 2 Gbps.

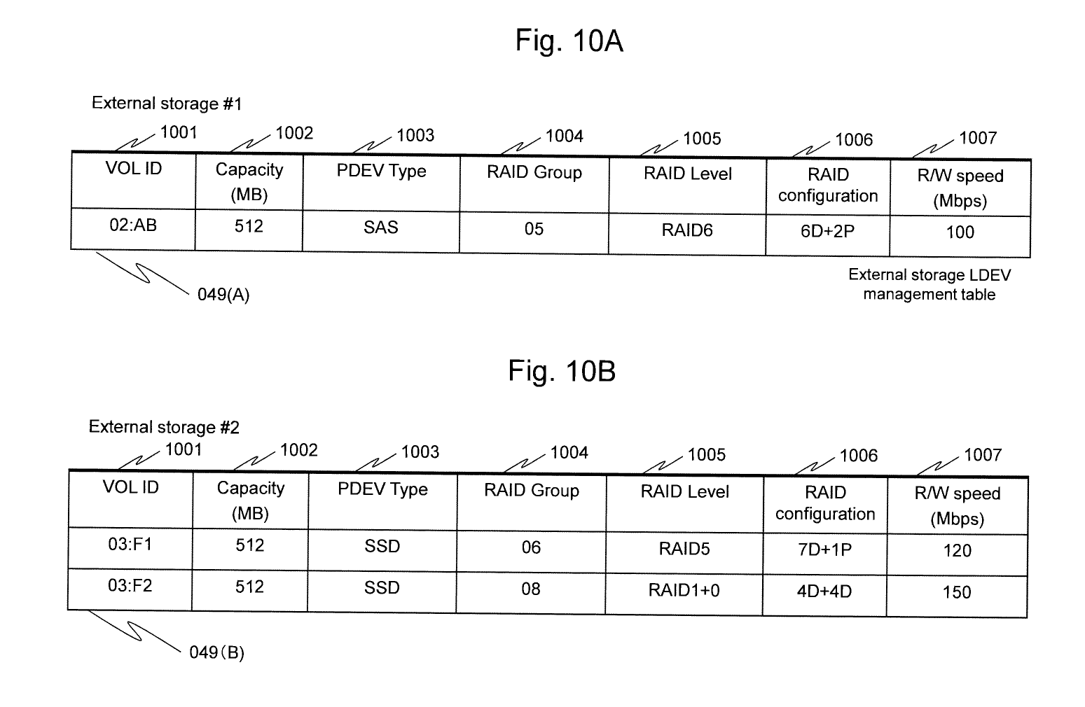

FIG. 10A is a diagram showing an example of the configuration of a VOL management table 049(A) stored in the control memory 114 of external storage #1. FIG. 10B is a diagram showing an example of the configuration of a VOL management table 049(B) stored in the control memory 114 of external storage #2.

Since the configuration of the external storage VOL management tables 049(A) and 049(B) are the same, only one (049(A)) will be explained. Specifically, for example, the VOL management table 049(A) comprises the following information for each external VOL:

a VOL ID 1001, which is the identification number of an external VOL 036;

a capacity 1002 denoting the capacity of the external VOL 036;

a PDEV Type 1003 denoting the type of the multiple PDEVs, which constitute the basis of the external VOL 036;

a RAID group 1004 denoting the RAID group 035 comprising the multiple PDEVs, which constitute the basis of the external VOL 036;

a RAID level 1005 denoting the level of the RAID group 035;

a RAID configuration 1006 denoting the configuration of the RAID group 035; and

a R/W (read/write) speed 1007 denoting either the amount of data read or the amount of data written per second to an EVOL 036.

Specifically, for example, external VOL “02:AB” has a capacity of 512 MB and a R/W speed of 100 Mbps, and is based on RAID group “05”, which comprises multiple PDEVs of disk type “SAS”. The RAID group “05” is configured with six data disks and two parity disks (6D+2P), and is RAID level 6.

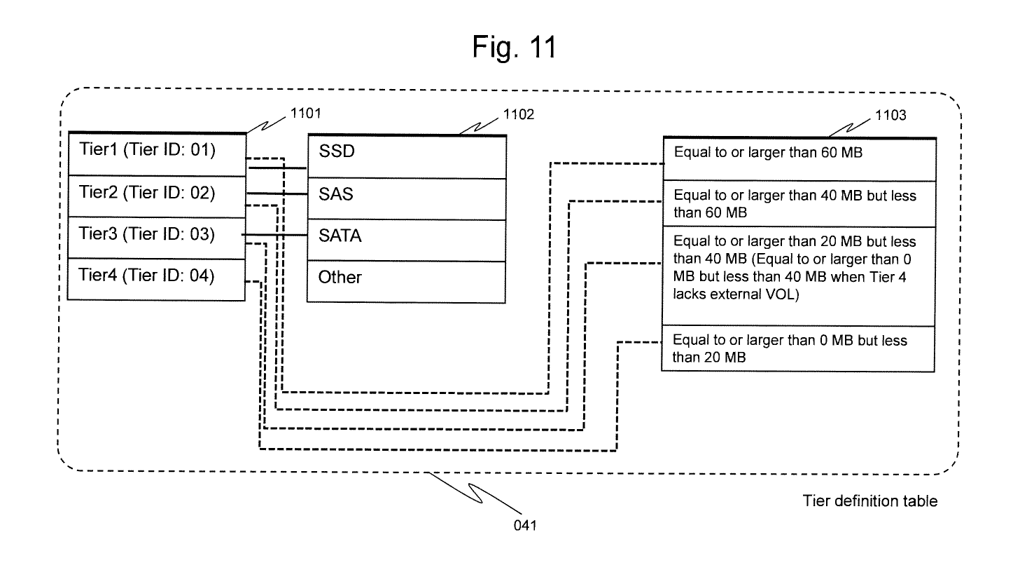

FIG. 11 shows an example of the configuration of the tier definition table.

The tier definition table 041 is for defining a tier. Specifically, for example, this table 041 comprises the following information for each tier:

a tier ID 1101, which is the identification number of a tier;

a PDEV type 1102 associated with the tier; and

a permissible range 1103 of average I/Os (refer to FIG. 6) of the VOL belonging to the tier.

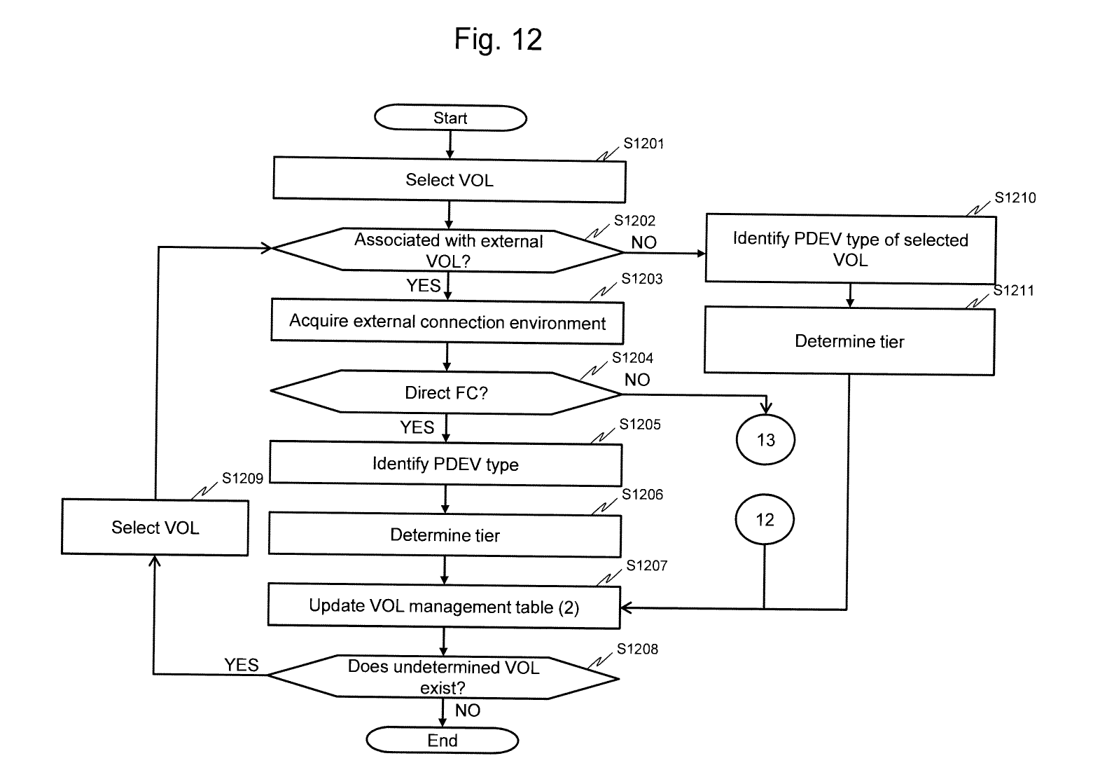

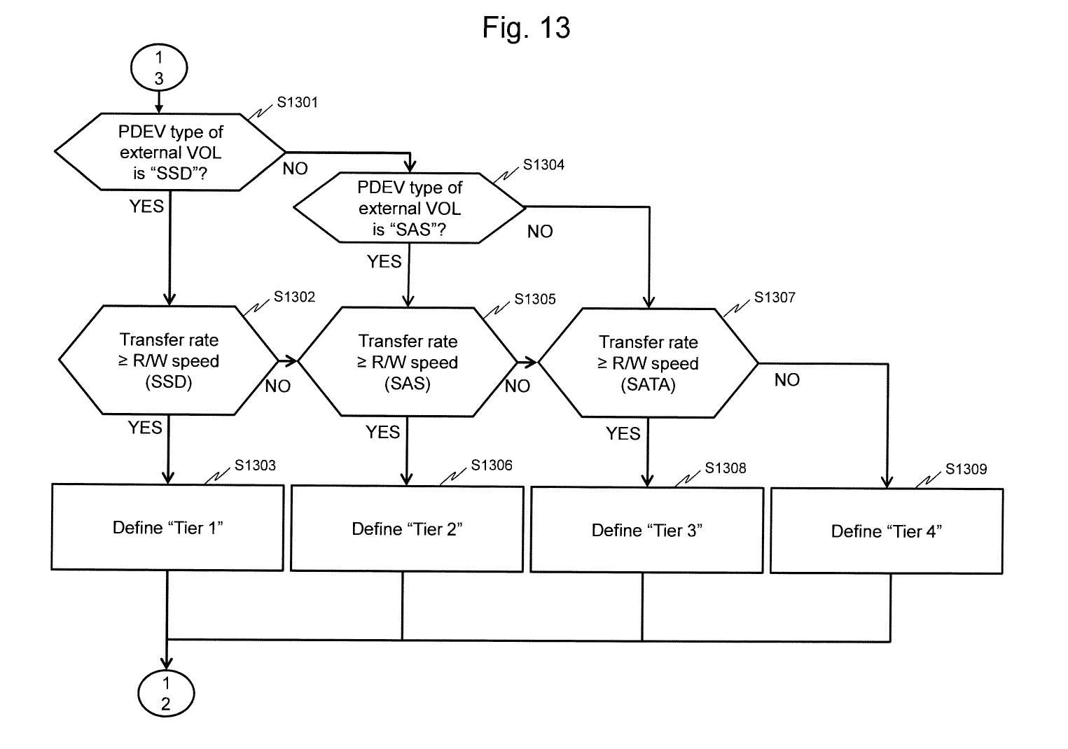

Specifically, for example, “SSD” is the type of the PDEVs, which constitute the basis of the VOL belonging to tier “01”. The permissible range of average I/Os of the VOL belonging to the tier “01” is equal to or larger than 60 MB. The tier table 041 is used in the tier determination processing of FIGS. 12 and 13.

FIG. 12 is one part of an example of a flowchart of a tier determination process. FIG. 13 is the remaining part of this flowchart. The tier determination process is performed by the controller of the storage system 130, but may be performed any other apparatus (for example, either the host 110 or the management apparatus 120). For example, either the management apparatus 120 or the host 110 may acquire information from the tables of the storage system 130 and the external storage 140, and based on the acquired information, may perform the tier determination process.

In S1201, a program selects one VOL 036. Specifically, the program, for example, references the VOL management table (2) 046 and identifies one VOL 036 having the smallest ID 091.

In S1202, the program determines whether or not there is an external VOL 036 mapped to the selected VOL 036. Specifically, for example, the program references the VOL management table (2) 046 and determines whether or not there is an external VOL 092, which corresponds to the VOL of ID 091 identified in S1201 (or S1209). In a case where the result of the determination is affirmative (S1202: Yes), the program proceeds to S1203. Alternatively, in a case where the result of the determination is negative (S1202: No), the program moves to S1210.

In S1210, the program identifies the PDEV type of the selected VOL 036. Specifically, for example, the program references the VOL management table (1) 044 and identifies the PDEV type 073 corresponding to VOL ID 071 identified in S1201.

In S1211, the program identifies the tier to which the selected VOL 036 belongs. Specifically, for example, the program references the tier definition table 041 and identifies the tier ID 1101, which matches the PDEV type 1102 identified in S1210. Thereafter, the program moves to S1207. Aside from the PDEV type, the RAID level and so forth may also be taken into account at tier determination.

In S1203, the program acquires an external connection environment. Specifically, for example, the program references the VOL management table (2) 046 and identifies the external connection environment 097 corresponding to the ID 091 identified in S1201 (or S1209).

In S1204, the program determines whether or not the external connection environment identified in S1203 is an FC direct connection. In the case of an FC direct connection, the program proceeds to S1205. In a case where the external connection environment is other than the FC direct connection, the program moves to the flow of processing of FIG. 13. “FC direct connection” signifies that the external storage is coupled to the storage system via either a single FC cable, or parallelly via multiple FC cables. That is, as shown in the example of FIG. 2, the external storage is coupled to the storage system by way of a communication network 160 such as a SAN, but the configuration does not have to be such that coupling is via a communication network 160. The external storage may also be coupled to the storage system using a FC direct connection, that is, via a single FC cable, or parallelly via multiple FC cables.

In S1205, the program identifies the PDEV type of the selected VOL 036. Specifically, for example, the program requests the external storage 140 to send external storage VOL management table 049(A) or 049(B). Then, the program references the external storage 140 to send external storage VOL management table 049(A) or 049(B) received from the external storage 140, and identifies the PDEV type 1003 corresponding to the VOL ID 1001 identified in S1201 (or S1209). Here, the storage system 130 requests that the external storage system 140 send the external storage VOL management table 049(A) or 049(B), but the present invention is not limited to this. For example, the storage system 130 may send the external storage 140 the VOL ID 1001 identified in S1201 and request that the external storage 140 send the PDEV type identified by the external storage 140. Or, the external storage 140 may send external storage VOL management table 049(A) or 049(B) to the storage system 130 on a regular basis, and the storage system 130 may reference the external storage VOL management table 049(A) or 049(B), which is stored in its own control memory 014.

In S1206, the program determines the tier to which the selected VOL 036 belongs. Specifically, for example, the program references the tier definition table 041 and identifies the tier ID 1101, which matches the PDEV type 1102 identified in S1205. Thereafter, the program proceeds to S1207. Aside from the PDEV type, the RAID level and so forth may also be taken into account at tier determination.

In S1207, the program updates the VOL management table (2) 046. Specifically, for example, the program records the ID 1101 identified in S1206 (or S1211) in the tier ID 095 of the VOL management table (2) 046.

In S1208, the program determines whether or not a next VOL 036 exists. Specifically, for example, the program references the VOLs of the VOL management table (2) 046 and determines whether or not a VOL 036 with a small ID 091 exists subsequent to the ID identified in S1201. In a case where the relevant VOL exists, the program moves to S1209. In a case where the relevant VOL does not exist, this processing ends.

In S1209, the program identifies a VOL 036 with a small ID 091 subsequent to the ID identified in S1201 (or S1209) from the VOL management table (2) 046. Then, the program moves to S1202.

In a case where the determination in S1204 of FIG. 12 is No, that is, a case in which the VOL 036 identified in S1201 (or S1209) is mapped to an external VOL (that is, it is an EVOL), and, in addition, the external connection environment 097 (refer to FIG. 9) is other than an FC direct connection, the processing of S1301 and after is performed.

In S1301, the program determines whether or not the PDEV type of the PDEVs, which constitute the basis of the external VOL 036, is “SSD”. Specifically, for example, the program determines whether or not the PDEV type identified in S1210 is “SSD”. In a case where the result of the determination is that the PDEV type is SSD (S1301: Yes), the program proceeds to S1302. Alternatively, in a case where the PDEV type is not SSD (S1301: No), that is, a case in which the PDEV type is either SAS or SATA in this example, the program moves to S1304.

In S1304, the program determines whether or not the PDEV type of the PDEVs, which constitute the basis of the external VOL 036, is “SAS”. Specifically, for example, the program determines whether or not the PDEV type identified in S1210 is “SAS”. In a case where the result of the determination is that the PDEV type is SAS (S1304: Yes), the program proceeds to S1305. Alternatively, in a case where the PDEV type is not SAS (S1304: No), that is, a case in which the PDEV type is SATA in this example, the program moves to S1307.

In S1302, the program determines whether or not the transfer speed between the selected VOL (EVOL) and the external VOL is either the same as or faster than the R/W speed of the PDEV (SSD), which constitutes the basis of the relevant external VOL. Specifically, for example, the program references the VOL management table (2) 046, identifies the transfer speed of the external VOL 092 and the external connection environment 097 corresponding to the VOL ID 091 identified in S1201 (or S1209), and, in addition, references the external storage VOL management tables 049(A) and 049(B), and identifies the R/W speed 1007 corresponding to the identified external VOL ID 1001. Then, the program determines whether or not the identified transfer speed is either the same as or faster than the R/W speed. In a case where the result of the determination is affirmative (S1302: Yes), the program proceeds to S1303. Alternatively, in a case where the result of the determination is negative (S1302: No), the program moves to S1305.

In S1303, the program defines the tier to which the VOL identified in S1201 (or S1209) belongs as “tier 1”. That is, in a case where the transfer speed between the VOL identified in S1201 (or S1209) and the external VOL is either the same as or faster than the SSD R/W speed, this VOL is determined to be able to produce SSD performance, and is defined as belonging to “tier 1”. Thereafter, the program moves to S1207 (FIG. 12).

In S1305, the program determines whether or not the transfer speed between the selected VOL and the external VOL is either the same as or faster than the R/W speed of the PDEV (SAS), which constitutes the basis of the relevant external VOL. Specifically, for example, the program references the VOL management table (2) 046, identifies the transfer speed of the external VOL 092 and the external connection environment 097 corresponding to the VOL ID 091 identified in S1201 (or S1209), and, in addition, references the external storage VOL management tables 049(A) and 049(B), and identifies the R/W speed 1007 corresponding to the identified external VOL ID 1001. Then, the program determines whether or not the identified transfer speed is either the same as or faster than the identified R/W speed. In a case where the result of the determination is affirmative (S1305: Yes), the program proceeds to S1306. Alternatively, in a case where the result of the determination is negative (S1305: No), the program moves to S1307.

In S1306, the program defines the tier to which the VOL identified in S1201 (or S1209) belongs as “tier 2”. That is, in a case where the transfer speed between the VOL identified in S1201 (or S1209) and the external VOL is either the same as or faster than the SAS R/W speed, the selected VOL is determined to be able to produce all of the performance of the SAS drive, and is defined as belonging to “tier 2”. Thereafter, the program moves to S1207 (FIG. 12).

In S1307, the program determines whether or not the transfer speed between the selected VOL and the external VOL is either the same as or faster than the R/W speed of the PDEV (SATA), which constitutes the basis of the relevant external VOL. Specifically, for example, the program references the VOL management table (2) 046, identifies the transfer speed of the external VOL 092 and the external connection environment 097 corresponding to the VOL ID 091 identified in S1201 (or S1209), and, in addition, references the external storage VOL management tables 049(A) and 049(B), and identifies the R/W speed 1007 corresponding to the identified external VOL ID 1001. Then, the program determines whether or not the identified transfer speed is either the same as or faster than the identified R/W speed. In a case where the result of the determination is affirmative (S1307: Yes), the program proceeds to S1308. Alternatively, in a case where the result of the determination is negative (S1307: No), the program moves to S1309.

In S1308, the program defines the tier to which the VOL identified in S1201 (or S1209) belongs as “tier 3”. That is, in a case where the transfer speed between the VOL identified in S1201 (or S1209) and the external VOL is either the same as or faster than the SATA R/W speed, the selected VOL is determined to be able to produce all the performance of the SATA drive, and is defined as belonging to “tier 3”. Thereafter, the program moves to S1207 (FIG. 12).

In S1309, the program defines the tier to which the VOL identified in S1201 (or S1209) as “tier 4”. In other words, tier 4 is classified as other. That is, in a case where the transfer speed between the VOL identified in S1201 (or S1209) and the external VOL is slower than the SATA R/W speed, the selected VOL is determined to be lower than SATA drive performance, and is defined as belonging to “tier 4”. Thereafter, the program moves to S1207 (FIG. 12).

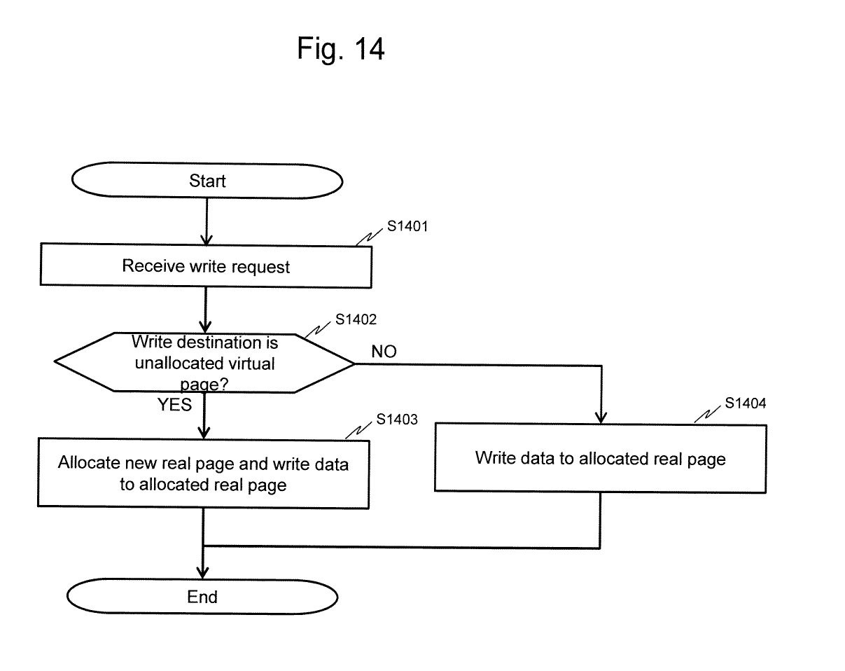

FIG. 14 is a flowchart of a data write process. The data write process is a thin provisioning write process. The data write process is performed by the storage system controller.

In S1401, the program receives a write request issued from the host 110.

In S1402, the program determines whether or not a real page has yet to be allocated to the write-destination virtual page. Specifically, for example, the program references the VVOL management table 043 and identifies a real page ID 064 corresponding to the write-destination VVOL ID 061 and virtual page ID 062 conforming to the write request received in S1401. In a case where the identified ID 064 is a value (a numeral is recorded in the example of FIG. 6) signifying allocated (S1402: No), the program moves to S1404. Alternatively, in a case where the identified ID 064 is a value (“NA” is recorded in the example of FIG. 6) signifying unallocated (S1402: Yes), the program moves to S1403.

In S1403, the program stores write data conforming to the write request received in S1401 in the real page 034a allocated to the write-destination virtual page 033a. Specifically, for example, the program references the VVOL management table 043, identifies the real page ID 064 corresponding to the write-destination virtual page ID 061, stores the write data in the real page 034a identified from the identified ID 064, and ends this processing.

In S1404, the program allocates an allocatable real page 034a from the pool 034 to the write-destination virtual page 033a. Then, the program stores the write data in the real page 034a allocated to the virtual page 033a. Specifically, for example, the program retrieves a real page 034a to which a virtual page 033a is not allocated, and allocates the write-destination virtual page 033a to the identified real page 034a. The real page to be allocated may be an unallocated real page belonging to a specified tier (the default tier). Then, the program registers the ID of the allocated real page and the ID of the pool to which this real page belongs in the VVOL management table 043. In addition, the program references the pool management table 042, identifies the tier ID 052 corresponding to the real page of the identified pool, registers the ID of the identified tier in the VVOL management table 043, and ends this processing.

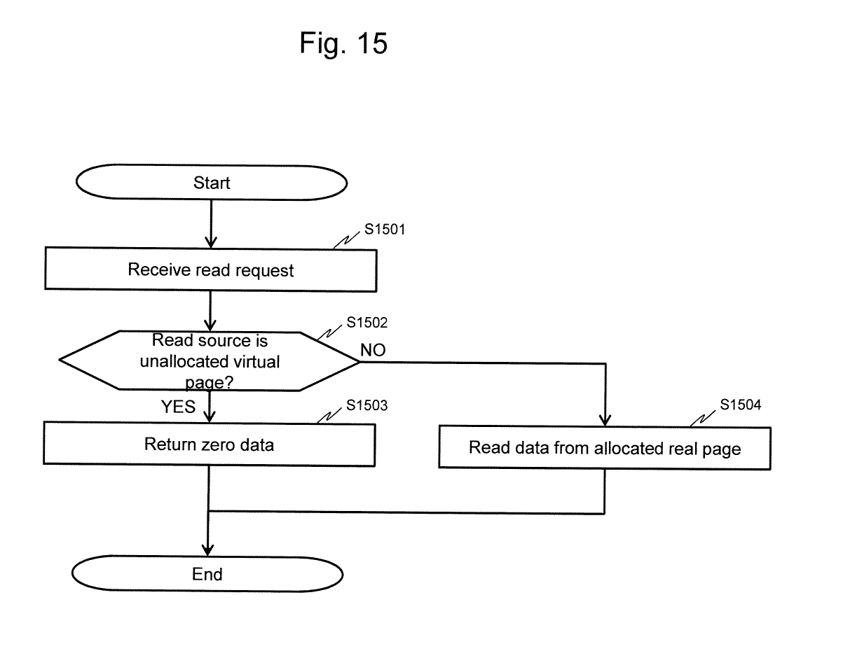

FIG. 15 is a flowchart of a data read process. The data read process is performed by the storage system controller.

In S1501, the program receives a read request issued from the host.

In S1502, the program determines whether or not a real page 034a has yet to be allocated to the read-source virtual page 033a. Specifically, for example, the program references the VVOL management table 043 and identifies the real page ID 064 corresponding to the read-source VVOL ID 061 and the virtual page ID 062 conforming to the read request of S1501. In a case where the identified ID 064 is a value (a numeral is recorded in the example of FIG. 6) signifying allocated (S1502: No), the program moves to S1504. Alternatively, in a case where the identified ID 064 is a value (“NA” is recorded in the example of FIG. 6) signifying unallocated (S1502: Yes), the program moves to S1503.

In S1504, the program reads data from the real page 034a allocated to the read-source virtual page 033a. Specifically, for example, the program references the VVOL management table 043, identifies the ID 064 corresponding to the read-source virtual page ID 061, reads the data stored in the real page 034a identified from the identified ID 064, sends this data to the host 110, and ends the processing.

In S1503, the program responds to the host to the effect that a real page 034a is not allocated to the read-source virtual page 033a. Specifically, for example, the program sends zero data (data that is only zeros and no ones) and another predetermined data pattern to the host, and ends the processing.

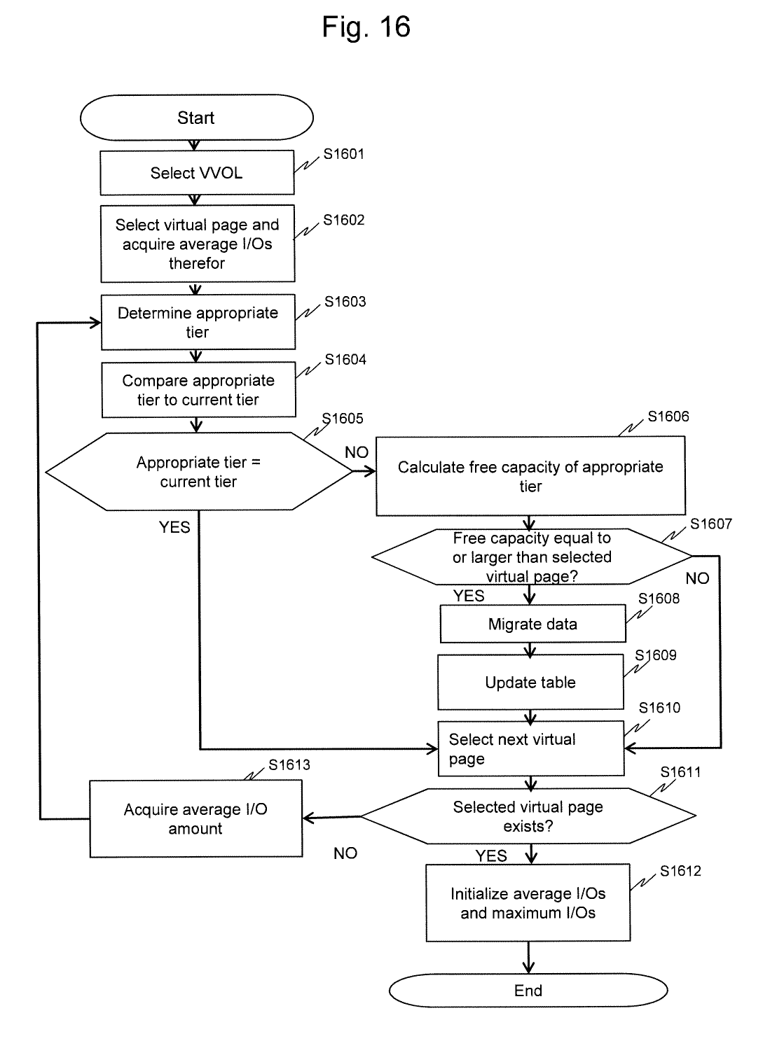

FIG. 16 is a flowchart of a dynamic tiering process.

The dynamic tiering process allocates a virtual page 033a to an appropriate tier in accordance with the quantity of average I/Os (the average I/Os frequency) from the host 110 to the virtual page 033a. This process is performed by the controller of the storage system 130, but may be performed by any other apparatus (for example, the host 110 or the management apparatus 120). For example, either the management apparatus 120 or the host 110 may acquire information from the tables of the storage system 130 and the external storage 140, and based on the acquired information, may perform the dynamic tiering process.

This process may be executed on a regular basis, or may be executed by the management apparatus at a specified time period.

In S1601, the program selects a VVOL 032. Specifically, for example, the program references the VVOL management table 043 and identifies one VVOL 032 with the smallest ID 061.

In S1602, the program selects one virtual page 033a from the selected VVOL 032, and acquires the average I/Os 066 of this virtual page 033a. Specifically, for example, the program references the VVOL management table 043, identifies one virtual page 033a with the smallest ID 062 from the VVOL 032 identified in S1601, and identifies the average I/Os 066 of the identified virtual page 033a.

In S1603, the program determines the appropriate tier for the selected virtual page 033a based on the average I/Os 066 acquired in S1602. Specifically, for example, the program references the tier definition table 041, identifies the permissible range 1103 of I/Os within which the average I/Os 066 identified in S1602 exist, and identifies the tier ID 1101 corresponding to the identified permissible I/O range 1103.

In S1604, the program compares the appropriate tier to the current tier with respect to the selected virtual page 033a. Specifically, for example, the program references the VVOL management table 043 and identifies the tier ID 065 corresponding to the virtual page ID 062 identified in S1602. Then, the program compares the identified ID 065 to the tier ID identified in S1603.

In S1605, the program determines whether or not the IDs of the appropriate tier and the current tier compared in S1604 are the same. In a case where the result of the determination is that the IDs of the appropriate tier and the current tier are the same (S1605: Yes), the program moves to S1610. Alternatively, in a case where the IDs of the appropriate tier and the current tier are not the same (S1605: No), the program moves to S1606.

In S1606, the program calculates the free capacity of the appropriate tier with respect to the selected virtual page. Specifically, for example, the program references the pool management table 042 to identify the used percentage 058 corresponding to the tier ID 052 identified in S1603, references the VOL management table (2) 046 to identify the capacity 093 for the tier ID 095 identified in S1603, and calculates the free capacity from the identified capacity and the identified used percentage 058.

In S1607, the program determines whether or not the free capacity of the appropriate tier (for example, the free capacity calculated in S1606) is equal to or larger than the capacity of the selected virtual page. In a case where the result of the determination is that the free capacity of the appropriate tier is equal to or larger than the capacity of the selected virtual page (S1607: Yes), the program proceeds to S1608. Alternatively, in a case where the free capacity of the appropriate tier is less than the capacity of the selected virtual page (S1607: No), the program moves to S1610.

In S1608, the program migrates data in the real page allocated to the selected virtual page to a free real page 034a in the pool 034 belonging to the appropriate tier.

In S1609, the program updates the pool management table 042 and the VVOL management table 043. In other words, the program allocates the migration-destination real page to the virtual page instead of the migration-source real page. Specifically, for example, the program updates the used capacity 055 and the used percentage 058 of the pool management table 042, and updates the VVOL ID 063, the Pool ID 064, and the tier ID 065 of the VVOL management table 043.

In S1610, the program identifies the next virtual page 033a with a small ID 062 from the VVOL selected in S1601.

In S1611, the program, for example, references the VVOL management table 043 and determines whether or not an ID 062 of the virtual page 033a identified in S1610 exists. In a case where the result of the determination is that the ID 062 exists (S1611: Yes), the program proceeds to S1612. Alternatively, in a case where the ID 062 does not exist (S1611: No), the program moves to S1613.

In S1613, the program acquires average I/Os 066 of the virtual page 033a identified in S1610. Specifically, the program references the VVOL management table 043 and identifies the average I/Os 066 of the virtual page ID 062 identified in S1610.

In S1612, the program initializes the average I/Os 066 and the maximum I/Os 067. Specifically, for example, the program initializes the values of the average I/Os 066 and maximum I/Os 067 of all the virtual pages in the VVOL 032 of ID 061 selected in S1601 with respect to the VVOL management table 043, and ends the processing.

In this example, the appropriate tier is determined using the average I/Os 066, but the appropriate tier may also be determined using the maximum I/Os 067.

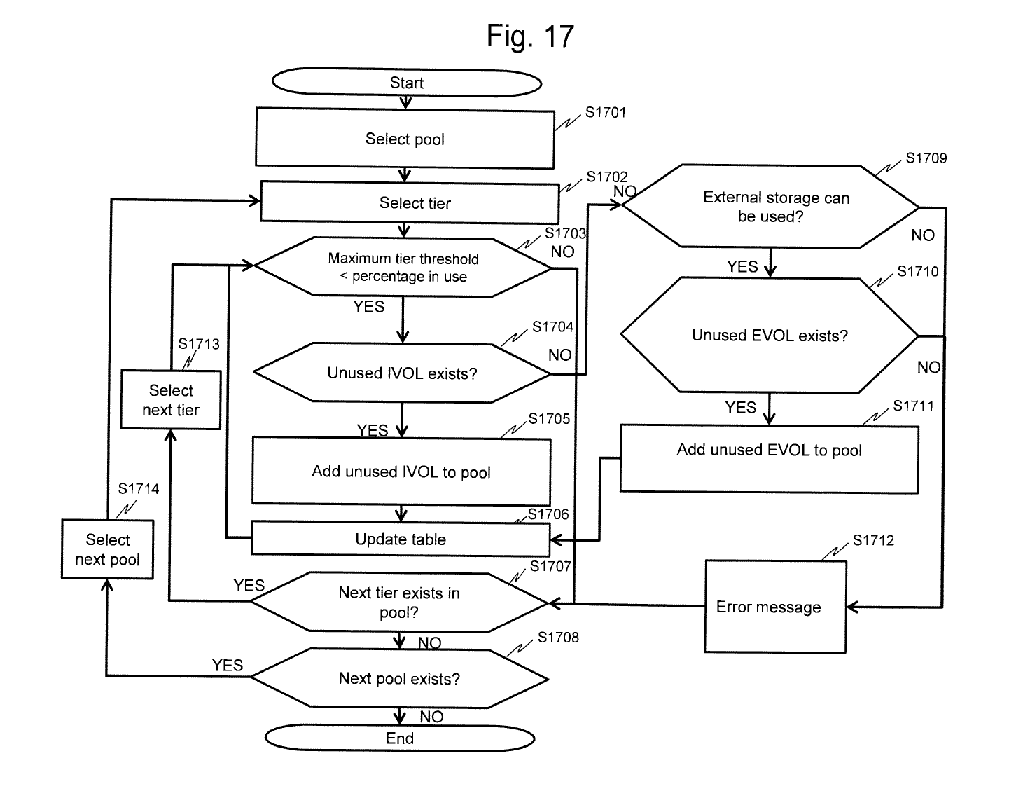

FIG. 17 is a flowchart of a pool capacity scale-up process. The pool capacity scale-up process is performed by the controller of the storage system 130, but may be performed by any other apparatus (for example, the host 110 or the management apparatus 120). For example, the management apparatus 120 or the host 110 may acquire information from the tables of the storage system 130 and the external storage 140, and, based on the acquired information, may perform the pool capacity scale-up process.

In S1701, the program selects one pool 034. Specifically, for example, the program references the pool management table 042 and identifies a pool with the smallest ID 051.

In S1702, the program selects one tier included in the selected pool. Specifically, for example, the program references the pool management table 042 and identifies the tier with the smallest ID 052 from the pool 034 selected in S1701.

In S1703, the program determines whether or not the current used percentage of the selected tier exceeds the maximum threshold. Specifically, for example, the program determines whether or not the used percentage 058 of the tier identified in S1702 is larger than the tier maximum threshold 056. In a case where the result of the determination is that the used percentage 058 is larger than the tier maximum threshold 056 (S1703: Yes), the program proceeds to S1704. Alternatively, in a case where the used percentage 058 is equal to or smaller than the tier maximum threshold 056 (S1703: No), the program moves to S1707.

In S1704, the program determines whether or not an unused IVOL 036, which should belong to the same tier as the selected tier, exists. Here, an IVOL is preferentially added to the pool as the VOL to be added over an EVOL. Specifically, for example, the program references the VOL management table (2) 046, and determines whether or not there is a VOL (that is, an IVOL), which is not an external VOL, corresponding to the tier of the same ID 095 as the tier identified in S1702 (in the example shown in the drawing, “−” is recorded for the presence or absence of an external VOL 092), and, in addition, a VOL, which is not registered in the pool (in the example shown in the drawing “NA” is in ID 094). In a case where the result of the determination is affirmative (S1704: Yes), the program proceeds to S1705. Alternatively, in a case where the result of the determination is negative (S1704: No), the program moves to S1709.

In S1705, the program adds the selected unused IVOL 036 of the storage system 130 to the pool 034. Specifically, for example, the program adds the IVOL 036, the existence of which was confirmed in S1704, to the pool.

In S1706, the program updates the pool management table 042 and the VOL management table (2) 046. Specifically, for example, the program adds the ID 053, PDEV Type 054, and used capacity 055 of the added VOL to the pool management table 042. The program recalculates the post-VOL addition used percentage. The program updates the pool ID 094 of the VOL management table (2) 046. In addition, in a case where an external VOL 036 has been added, the program updates the presence or absence of the external VOL 092 of the VOL management table (2) 046.

In S1707, the program determines whether or not a next tier exists. Specifically, for example, the program references the pool management table 042, and determines whether or not there is a tier with the next smallest ID 052 with respect to the tier identified in S1702 (or S1713). In a case where the result of the determination is that there is a next tier (S1707: Yes), the program identifies this tier in S1713, and moves to S1703. Alternatively, in a case where there is not a next tier (S1707: No), the program proceeds to S1708.

In S1708, the program determines whether or not a next pool exists. Specifically, for example, the program references the pool management table 042, and determines whether or not there is a pool with the next smallest ID 051 with respect to the pool identified in S1701 (or S1714). In a case where the result of the determination is that there is a next pool (S1708: Yes), the program identifies this pool in S1714, and moves to S1702. Alternatively, in a case where there is not a next pool (S1708: No), the program ends the processing.

In S1709, the program determines whether or not the external storage 140 can be used. Specifically, for example, the program references the external use table 045, and determines whether or not external use 082 is “ON” with respect to the pool selected in S1701 (or S1714). In a case where the result of the determination is that the external use 082 is “ON” (S1709: Yes), the program proceeds to S1710. Alternatively, in a case where the external use 082 is “OFF” (S1709: No), the program moves to S1712.

In S1710, the program determines whether or not an unused EVOL 036 that should belong to the same tier as the selected tier exists. Specifically, for example, the program references the VOL management table (2) 046, and determines whether or not there is a VOL (an EVOL) to which an external VOL corresponding to the tier of the same ID 095 as the tier identified in S1702 (or S1712) (in the example shown in the drawing, a number is recorded for the presence or absence of an external VOL 092), and this VOL is not registered in the pool (in the example shown in the drawing “NA” is in ID 094). In a case where the result of the determination is affirmative (S1710: Yes), the program proceeds to S1711. Alternatively, in a case where the result of the determination is negative (S1710: No), the program moves to S1712.

In S1711, the program adds the unused EVOL 036 to the pool 034. Specifically, for example, the program adds the EVOL 036, the existence of which was confirmed in S1710, to the pool 034. Then, the program advances to the above-mentioned S1706, and updates the pool management table 042 and the VOL management table (2) 046.

In S1712, the program sends an error message to the management apparatus 120 (or the host 110). Specifically, for example, the program may send the error message via e-mail, or may use another method. After S1712, the program moves to the above-mentioned S1707.

After executing the pool scale-up process, the management apparatus may present information on the VOL allocated to the pool and information related to the post-pool scale-up process pool via the output device. In a case where the EVOL storage area has been leased from an external storage of a cloud provider, the cost incurred in accordance with the pool scale-up process may also be shown.

The pool capacity scale-up process explained above using FIG. 17 has the following characteristic features. In other words, the first characteristic feature is that an IVOL is preferentially added to a pool over an EVOL. This has the effect of making it possible to efficiently use the storage capacity inside the storage system. The second characteristic feature is that whether or not a storage area in the external storage is to be used can be configured for each pool, and an EVOL is added to a pool only in a case where the pool has been configured to enable the use of a storage area in the external storage. This has the effect of making it possible to properly use the storage area to be used in accordance with the importance of the stored data.

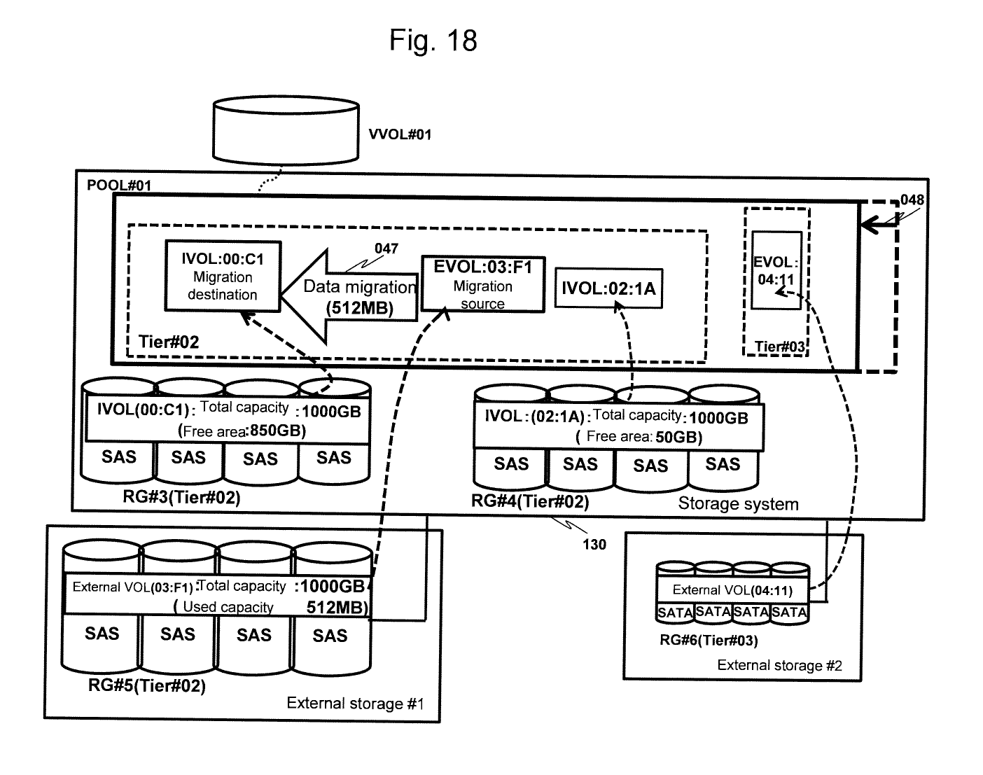

FIG. 18 is a diagram illustrating an overview of a pool scale-down process of Example 1.

In thin provisioning, a real page is allocated to a virtual page in accordance with a write process as shown in FIG. 14, but alternatively, a reclamation process, which cancels the allocation of a real page to a virtual page in accordance with a data deletion or the like, can also be executed. Therefore, there may be cases in which, even though the used capacity of a storage area in the pool 034 has been increased temporarily, the used capacity is decreased in accordance with continued operation. In this case, it is necessary to cancel (also called delete) the allocation of the pool VOL allocated to the relevant pool, and scale down the pool.

A pool scale-down process in this example preferentially selects an EVOL over an IVOL as the pool VOL targeted to be deleted from this pool, and migrates the data stored in this selected pool VOL to another pool VOL belonging to the same pool and the same tier as this pool VOL.

In the example shown in the drawing, tier #02 of pool #01 is scaled down. A pool #01 capacity equivalent to that denoted by the arrow 048 is scaled down. That is, the pool #01 is scaled down from the capacity denoted by the broken line to the capacity denoted by the solid line.

The pool scale-down is performed for each tier. That is, the pool scale-down is realized by migrating data in a pool VOL belonging to a tier to another VOL, and deleting the migration-source pool VOL. At this time, an EVOL is preferentially selected over an IVOL as the migration-source pool VOL. In addition, it is preferable that the migration-source pool VOL be the VOL with the smallest used capacity of the pool VOLs in the tier to which the migration-source pool VOL belongs. Alternatively, a pool VOL, which is in the same tier and has free capacity that is larger than the used capacity of the migration-source pool VOL, is selected as the migration-destination pool VOL (the pool VOL with the largest free capacity is preferable).

In the example shown in the drawing, tier #02 is the target. An EVOL (03:F1) to which an external VOL (03:F1) based on RAID group #5 of the external storage #1 is mapped, and an IVOL (00:C1) based on RAID group #3 in the storage system belong to the tier #2. The EVOL (03:F1) is the VOL with the smallest used capacity (used capacity of 512 MB) in the tier #2. The IVOL (00:C1) is a VOL with free capacity (free capacity of 815 MB) that is larger than the used capacity of the EVOL (03:F1). As indicated by arrow 047, 512 MB of data is migrated from the EVOL (03:F1) to the IVOL (00:C1). This makes it possible to delete the EVOL (03:F1) from the tier #2.

In this example, the EVOL is preferentially selected over the IVOL as the pool VOL to be deleted. This has the effect of making it possible to efficiently use the storage area of the storage system. Also, collecting data in a VOL in the storage system makes it possible to enhance the processing of the computer system.

In this example, data is migrated from a pool VOL to be deleted to a pool VOL belonging to the same pool, and, in addition, the same tier as the pool VOL to be deleted. For this reason, it is possible to prevent important data (for example, data with high average I/Os) from being migrated to a pool VOL belonging to a low tier, and unimportant data (for example, data with low average I/Os) from being migrated to a pool VOL belonging to a high tier.

In this example, the migration-destination pool VOL is unitary (in other words, the migration destination is not multiple VOLs), and a VOL with the smallest used capacity possible is selected as the migration-source pool VOL. This enables the time and load involved in data migration to be reduced.

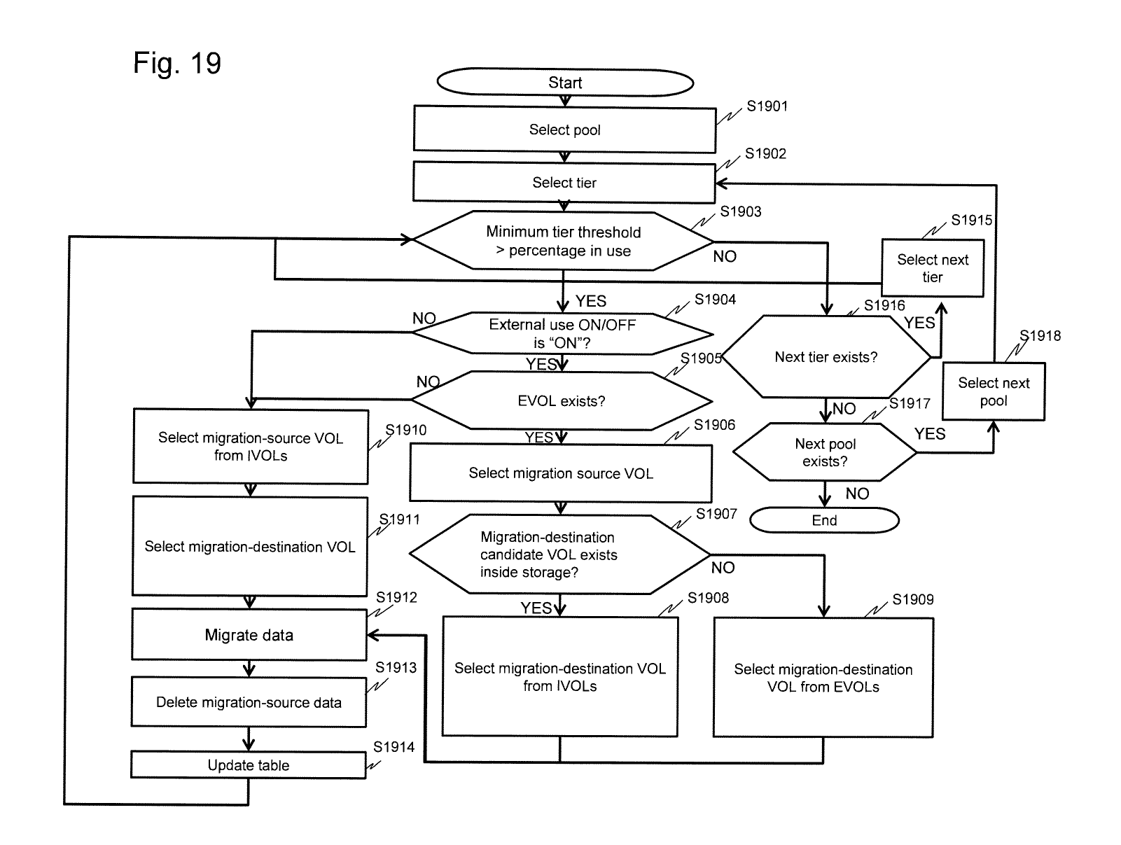

FIG. 19 is an example of a flowchart of a pool capacity scale-down process of Example 1. This process is performed by the controller of the storage system 130, but may be performed by any other apparatus (for example, the host 110 or the management apparatus 120). For example, either the management apparatus 120 or the host 110 may acquire information from the tables of the storage system 130 and the external storage 140, and, based on the acquired information, may perform the process.

In S1901, the program selects one pool. Specifically, for example, the program references the pool management table 042 and identifies one pool 034 with the smallest ID 051.

In S1902, the program selects one tier in the selected pool. Specifically, for example, the program references the pool management table 042 and identifies a tier with the smallest ID 052 in the pool identified in S1901.

In S1903, the program determines whether or not the current used percentage of the selected tier falls below the tier minimum threshold. Specifically, for example, the program determines whether or not the used percentage 058 of the tier identified in S1902 is less than the tier minimum threshold 057. In a case where the result of the determination is that the used percentage 058 is less than the tier minimum threshold (S1903: Yes), the program proceeds to S1904. Alternatively, in a case where the used percentage 058 is equal to or larger than the tier minimum threshold (S1903: No), the program moves to S1916.

In S1916, the program determines whether or not a next tier exists. Specifically, for example, the program references the pool management table 042, and determines whether or not there is a tier with the next smallest ID 052 with respect to the tier identified in S1902 (or S1915). In a case where the result of the determination is that a next tier exists (S1916: Yes), the program identifies this tier in S1915, and moves to S1903. Alternatively, in a case where the result of the determination is that there is not a next tier (S1916: No), the program proceeds to S1917.

In S1917, the program determines whether or not a next pool exists. Specifically, for example, the program references the pool management table 042, and determines whether or not there is a pool with the next smallest ID 051 with respect to the pool identified in S1901 (or S1918). In a case where the result of the determination is that there is a next pool (S1917: Yes), the program identifies this pool in S1918, and moves to S1902. Alternatively, in a case where the result of the determination is that there is not a next pool (S1917: No), the program ends the processing.

In S1904, the program determines whether or not the external storage 140 can be used. Specifically, for example, the program references the external use table 045, and determines whether or not the external use 082 is “ON” with respect to the pool selected in S1901 (or S1918). In a case were the result of the determination is that the external use 082 is “ON” (S1904: Yes), the program proceeds to S1905. Alternatively, in a case where the external use 082 is “OFF” (S1904: No), the program moves to S1910.

In S1905, the program determines whether or not an EVOL exists in the selected tier. Specifically, for example, the program references the pool management table 042, and determines whether or not a VOL with a PDEV Type 054 of “External” exists in the tier identified in S1902 (or S1914). In a case where the result of the determination is affirmative (S1905: Yes), the program proceeds to S1906. In a case where the result of the determination is negative (S1905: No), the program moves to S1910.

In S1906, the program selects the EVOL as the VOL of the migration source (hereinafter, migration-source VOL). The VOL selected here is an EVOL, which is preferentially selected over an IVOL. Specifically, the program identifies a VOL, which has been confirmed to exist in S1905, has a PDEV Type 054 of “External”, and has the smallest used capacity therein (the VOL with the smallest the used capacity 055 in the pool management table 042), and makes this the migration-source VOL. The migration-source VOL becomes the deletion target (the pool VOL for which the allocation to the pool is canceled). At this point, the program may also determine whether the current data can be stored in another VOL even though the allocation of the target EVOL to the pool is canceled (whether the used capacity exceeds the tier maximum threshold).

In S1907, the program selects a VOL to be a migration-destination candidate (hereinafter, migration-destination candidate VOL), and determines whether or not a migration-destination candidate VOL exists in the storage system 130 (whether or not there is an IVOL). The migration-destination candidate VOL here is a VOL with a free capacity in excess of the current used capacity of the migration-source VOL of the VOLs belonging to the same tier as the migration-source VOL. The VOL selected here is an IVOL, which is preferentially selected over an EVOL. Specifically, for example, the program performs the following processing:

references the VOL management table (2) 046, and identifies either one or multiple VOLs of the same tier as the migration-source pool VOL (a VOL or VOLs for which ID 094 and ID 095 are the same as the migration-source VOL) (hereinafter, called the identified VOL);

references the VOL management table (2) 046 and respectively identifies the capacities 093 of the identified VOLs;

references the pool management VOL 042 and respectively identifies the used capacities 055 of the identified VOLs;

respectively calculates the free capacities of the identified VOLs based on the capacities and used capacities of the identified VOLs;

references the pool management table 042 and identifies the used capacity 055 of the migration-source VOL;

identifies the identified VOL with a free capacity that is larger than the used capacity of the migration-source VOL as the migration-destination candidate VOL; and

references the VOL management table (2) 046 and determines whether or not a pool VOL for which the presence or absence of an external VOL 092 is “−” exists with respect to the migration-destination candidate VOL. In a case where the result of the determination is affirmative (S1907: Yes), the program proceeds to S1908. Alternatively, in a case where the result of the determination is negative (S1907: No), the program moves to S1909.

In S1908, the program identifies an IVOL from among the migration-destination candidate VOLs. For example, in a case where multiple migration-destination candidate VOLs are identified at this time, one of these is identified as the migration-destination VOL. The migration-destination VOL identification process identifies the VOL having the maximum free capacity. The program then moves to S1912.

In S1909, the program identifies an EVOL from among the migration-destination candidate VOLs. For example, in a case where multiple migration-destination candidate VOLs are identified at this time, one of these is identified as the migration-destination VOL. The migration-destination VOL identification process identifies the VOL having the maximum free capacity. The program then moves to S1912.

In S1910, the program selects a VOL, which is an IVOL, and which has the smallest used capacity, as the migration-source VOL. Specifically, for example, the program identifies the VOL, which is a VOL for which the PDEV Type 054 in S1905 is other than “External” (in other words, an IVOL), and, in addition, which has the smallest used capacity therein (the VOL with the smallest used capacity 055 in the pool management table 042), and makes this the migration-source VOL.

In S1911, the program selects a VOL to be the migration-destination candidate (hereinafter, migration-destination candidate VOL) from multiple IVOLs. The migration-destination candidate VOL here is a VOL with a free capacity in excess of the current used capacity of the migration-source VOL of the VOLs belonging to the same tier as the migration-source VOL. Specifically, for example, the program performs the following processing:

references the VOL management table (2) 046, and identifies either one or multiple VOLs of the same tier as the migration-source VOL (a VOL or VOLs for which ID 094 and ID 095 are the same as the migration-source VOL) (hereinafter, called the identified VOL);

references the VOL management table (2) 046 and respectively identifies the capacities 093 of the identified VOLs;

references the pool management table 042 and respectively identifies the used capacities 055 of the identified VOLs;

respectively calculates the free capacities of the identified VOLs based on the capacities and used capacities of the identified VOLs;

references the pool management table 042 and identifies the used capacity 055 of the migration-source VOL; and

identifies the identified VOL with a free capacity that is larger than the used capacity of the migration-source VOL as the migration-destination candidate VOL. In a case where there are multiple migration-destination candidate VOLs, the program identifies one of these as the migration-destination VOL. The program may select how the migration-destination VOL is to be identified, such as identifying the VOL with the maximum free capacity.

In S1912, the program migrated the data of the migration-source VOL to the migration-destination VOL identified in S1908 (or S1909, S1911). The used capacity 055 of the migration-source VOL in the pool management table 042 may be added to the used capacity 055 of the migration-destination VOL at this time.

In S1913, the program deletes the data inside the migration-source VOL. The used capacity of the migration-source VOL of the pool management table 042 may be set to zero at this time.

In S1914, the program updates the pool management table 042, the VVOL management table 043, and the VOL management table (2) 046.

The program deletes the row of the migration-source VOL in the pool management table 042 from the table. The program changes the used percentage of the target tier.

The program updates the real page ID 064 in the VVOL management table 043 because the real page associated with the virtual page changes in accordance with the data migration of S1912.

The program changes the Pool ID of the migration-source VOL in the VOL management table (2) 046 to NA.

Then, the migration-source pool VOL constitutes a VOL, which is not allocated to any pool and can be used in a pool scale-up process thereafter.

The processing subsequent to the data deletion process explained using S1914 may be performed after the pool capacity scale-down process has ended.

After executing the pool scale-down process, the management apparatus may present information about the VOL for which the allocation to the pool was canceled and information related to the post-pool scale-down process pool via the output device. In a case where the EVOL storage area has been leased from an external storage of a cloud provider, the extent of the cost reduction effect as a result of the pool scale-down process may also be shown.

The pool capacity scale-down process explained above using FIG. 18 has the following characteristic features. The first characteristic feature is that an EVOL is preferentially allocated to a pool over an IVOL. The second characteristic feature is that an IVOL is preferentially selected over an EVOL as the migration destination of the data inside the VOL deleted from the pool. This has the effect of making it possible to efficiently use the storage capacity in the storage system. Also, collecting data in a VOL in the storage system makes it possible to enhance the processing of the computer system. Another characteristic feature takes into account the efficiency of data migration by selecting a VOL with the smallest used capacity as the VOL to be selected.

### Example 2

Example 2 will be explained hereinbelow. In so doing, the focus of the explanation will be on the points of difference with Example 1, and explanations of points in common with Example 1 will be either simplified or omitted. Components shared in common with Example 1 will be described using the same reference signs.

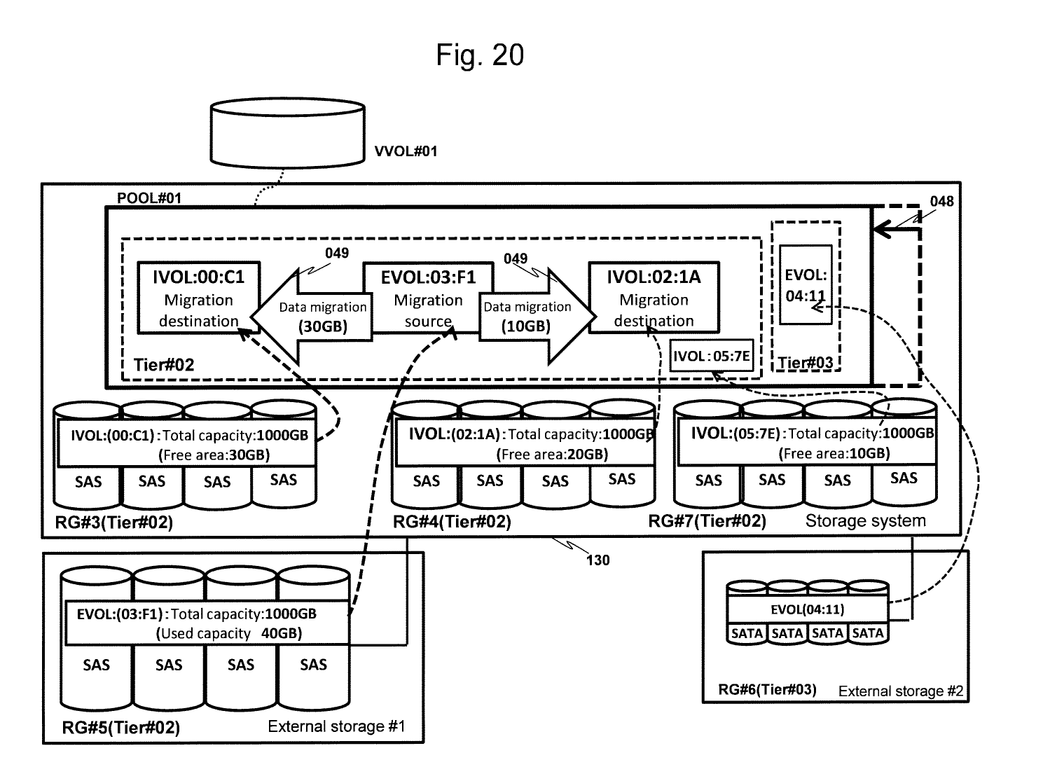

FIG. 20 is a diagram illustrating an overview of a pool capacity scale-down process of Example 2.

The pool scale-down process of this example migrates data stored in the VOL targeted to be deleted from the pool to multiple VOLs when downscaling the pool capacity.

That is, in this example, multiple migration-destination VOLs are selected. In so doing, multiple VOLs are selected such that the total free capacity is equal to or larger than the used capacity of the migration-source VOL.

In the example shown in the drawing, tier #2 is the target. An EVOL (03:F1), which is mapped to an external VOL (03:F1) based on RAID group #5 of the external storage #1, an IVOL (00:01) based on RAID group #3 and an IVOL (02:1A) based on RAID group #4 in the storage system belong to the tier #2. The EVOL (03:F1) is the VOL with the smallest used capacity (total used capacity of 512 MB) of the EVOLs in the tier #2. The total free capacity of the IVOL (00:C1) and the IVOL (02:1A) (free capacity of 50 GB) is larger than the used capacity of the EVOL (03:F1). As indicated by arrow 049, 50 GB of data is migrated from the EVOL (03:F1) to the IVOL (00:C1) and the IVOL (02:1A). This makes it possible to delete the EVOL (03:F1) from the tier #2.

In this example, multiple VOLs are the migration destination of the data. For this reason, for example, data can be migrated to a VOL in another storage system in addition to a VOL in one storage system, and load distribution can be expected to be performed throughout the entire computer system.

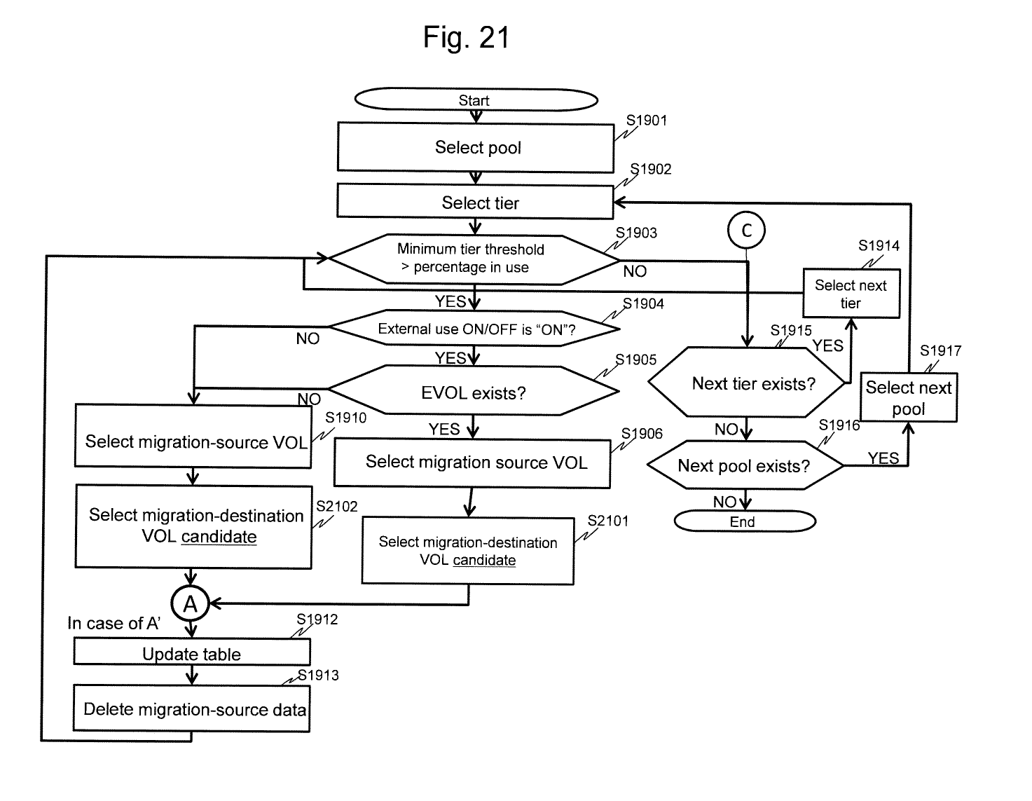

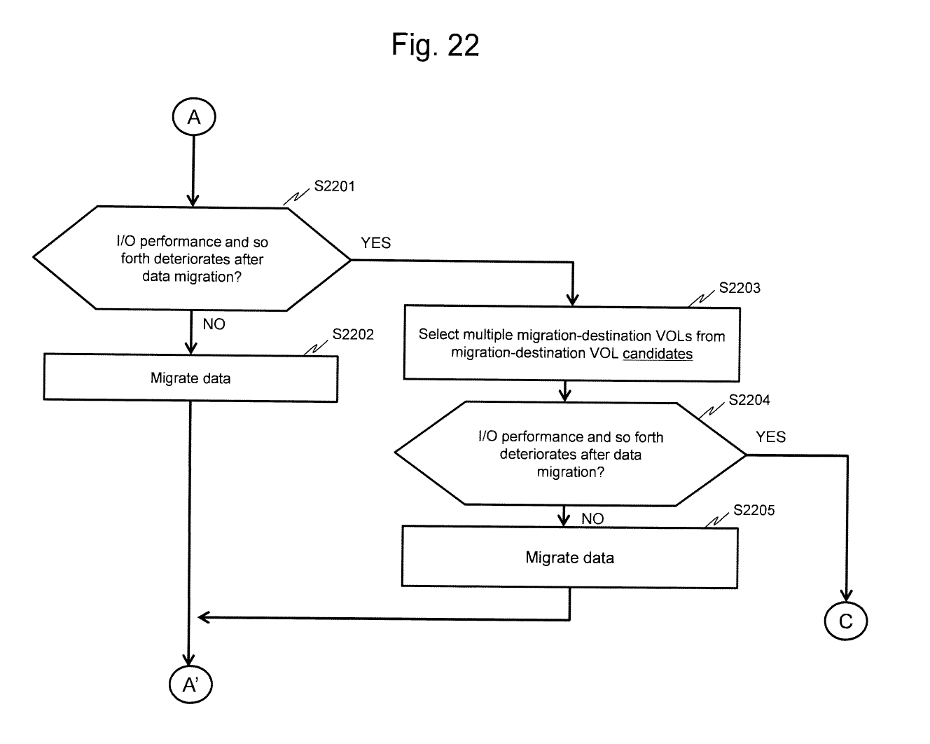

FIG. 21 is a first part of an example of a flowchart of a pool capacity scale-down process of Example 2. FIG. 22 is the second part of this flowchart. This process is performed by the storage system controller, but may be performed by any other apparatus (for example, the host 110 or the management apparatus 120). For example, either the management apparatus 120 or the host 110 may acquire information from the tables of the storage system 130 and the external storage 140, and based on the acquired information, may perform the process.

In the following explanation, the same reference sign will be used to describe a process that is the same as that in the flowchart of the pool capacity scale-down process of Example 1.

The processing of FIG. 22 (A in the drawing) is performed after selecting a candidate for the migration-destination VOL in S2101 and S2102. In a case where the result of the processing of FIG. 22 is A′, the processing moves to S1912. In a case where the result of the processing of FIG. 22 is A″, the processing moves to S1915.

In S2101, the program takes into account free capacity and selects either an EVOL or an IVOL as the migration-destination pool VOL candidate in the same tier of the same pool as the VOL selected as the migration-source VOL.

In S2102, the program takes into account free capacity and selects an IVOL as the migration-destination pool VOL candidate in the same tier of the same pool as the VOL selected as the migration-source VOL.

In S2201, the program determines whether system performance remains undegraded with respect to I/O (Input/Output) from the host in a case where a data migration has been performed to the migration-destination VOL. Specifically, for example, the program performs the determination for each migration-destination candidate VOL. Then, in a case where the performance of the storage system is equal to or greater than a prescribed performance subsequent to at least one of the migration-destination candidate VOLs being made the migration destination, the program selects one of these migration-destination candidate VOLs as the migration-destination VOL. In a case where an EVOL is included in the migration-destination candidate VOLs, the EVOL is preferentially selected over an IVOL. In a case where the result of the determination is that a migration-destination VOL has been selected (S2201: Yes), the program proceeds to S2202. Alternatively, in a case where a migration-destination candidate VOL has not been selected (S2201: No), the program moves to S2203.

In S2202, the program migrates the data of the migration-source VOL to the migration-destination VOL selected in S2201.

In S2203, the program selects multiple migration-destination VOLs from the multiple migration-destination candidate VOLs. Specifically, for example, the program selects multiple (for example, a prescribed number) of migration-destination VOLs from the migration-destination candidate VOLs identified in S2201. The selection of the migration-destination VOL, for example, may be preferentially performed beginning with a VOL having a lot of free capacity from among the migration-destination candidate VOLs, or selection may be performed on the basis of a different rule. Only multiple IVOLs may be selected, or only multiple EVOLs may be selected.

In S2204, the program determines whether or not the performance of the storage system is equal to or greater than a prescribed performance subsequent to data having been migrated to the multiple migration-destination candidate VOLs identified in S2203. Then, in a case where the storage system performance is equal to or greater than the prescribed performance when at least one of the multiple migration-destination candidates has been made the migration destination, the program selects this migration-destination candidate as the migration-destination. In a case where the result of the determination is that a migration-destination candidate has been selected as the migration destination (S2204: Yes), the program proceeds to S2205. Alternatively, in a case where a migration-destination candidate has not been selected as the migration destination (S2204: No), the program moves to C since a migration-destination candidate was not found.

In S2205, the program migrates the data of the migration-source VOL to each migration-destination VOL comprising the migration-destination candidates selected in S2204.

This migration process has the effect of enabling data inside the pool VOL to be deleted to be migrated to multiple migration-destination VOLs with an eye toward post-data migration I/O and other performance, making it possible to guarantee I/O and other performance after pool downscaling.

### Example 3

Example 3 will be explained below. In so doing, the focus of the explanation will be on the points of difference with Example 1, and explanations of the points in common with Example 1 will be either simplified or omitted. Also, components shared in common with Example 1 will be described using the same reference signs. In the following explanation, a real page, which stores significant data and is allocated to a virtual page may be called a “valid page”, and a real page, which stores insignificant data (a specific data pattern (for example, 0 data)) and is allocated to a virtual page may be called an “invalid page”. The invalid page differs from an empty page (an unallocated page), which is not allocated to a virtual page, in that it is allocated to a virtual page.

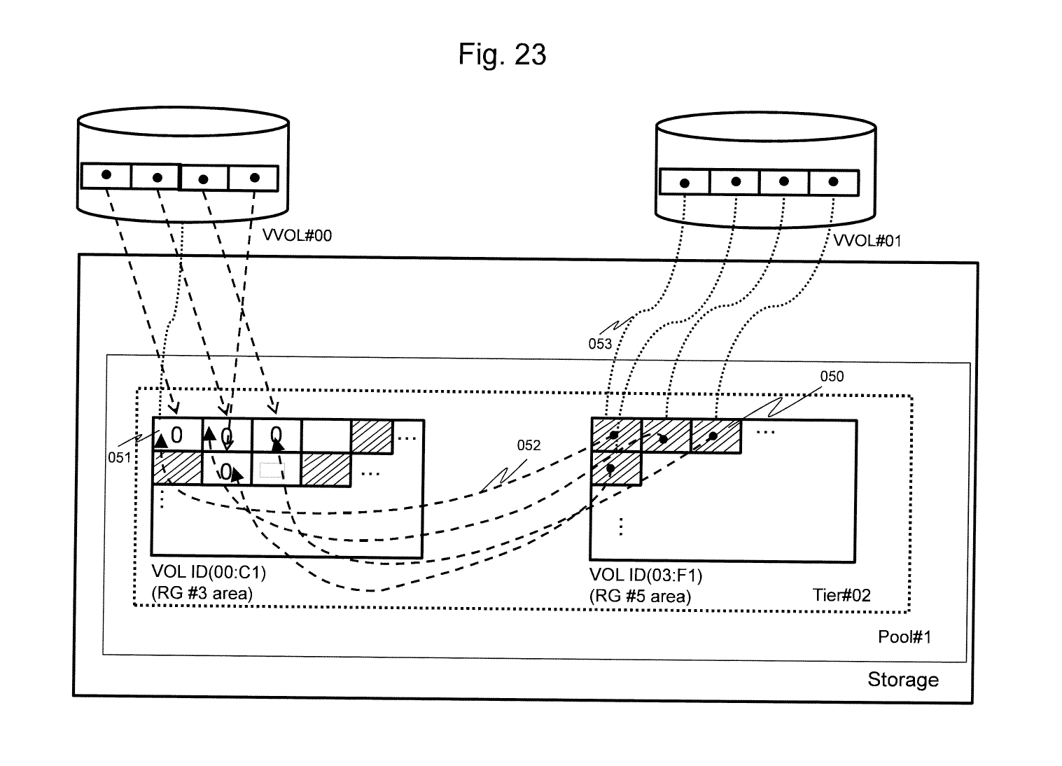

FIG. 23 is a diagram illustrating an overview of a pool capacity scale-down process of Example 3.

In the pool scale-down process of Example 3, a page as well as a VOL is decided on as a migration source and a migration destination. Specifically, for example, any real page is selected from the migration-source VOL as the migration source. Furthermore, a real page (invalid page), which stores insignificant data (for example, data comprising only the bit value 0) and is allocated to a VVOL is selected from within the migration-destination VOL as the migration destination. The invalid page is allocated to a virtual page as indicated by arrow 053. In the example shown in the drawing, a VOL (00:C1) based on the RAID group #3 is the migration-destination VOL, and a VOL (03:F1) based on the RAID group #5 is the migration-source VOL in tier #2. Data is migrated from multiple valid pages 050 in the VOL (03:F1) to multiple invalid pages 051 in the VOL (00:C1) as indicated by arrow 052.

In this example, an invalid page of the migration-destination VOL is the data migration destination. This makes it possible to reduce waste and make effective use of resources.

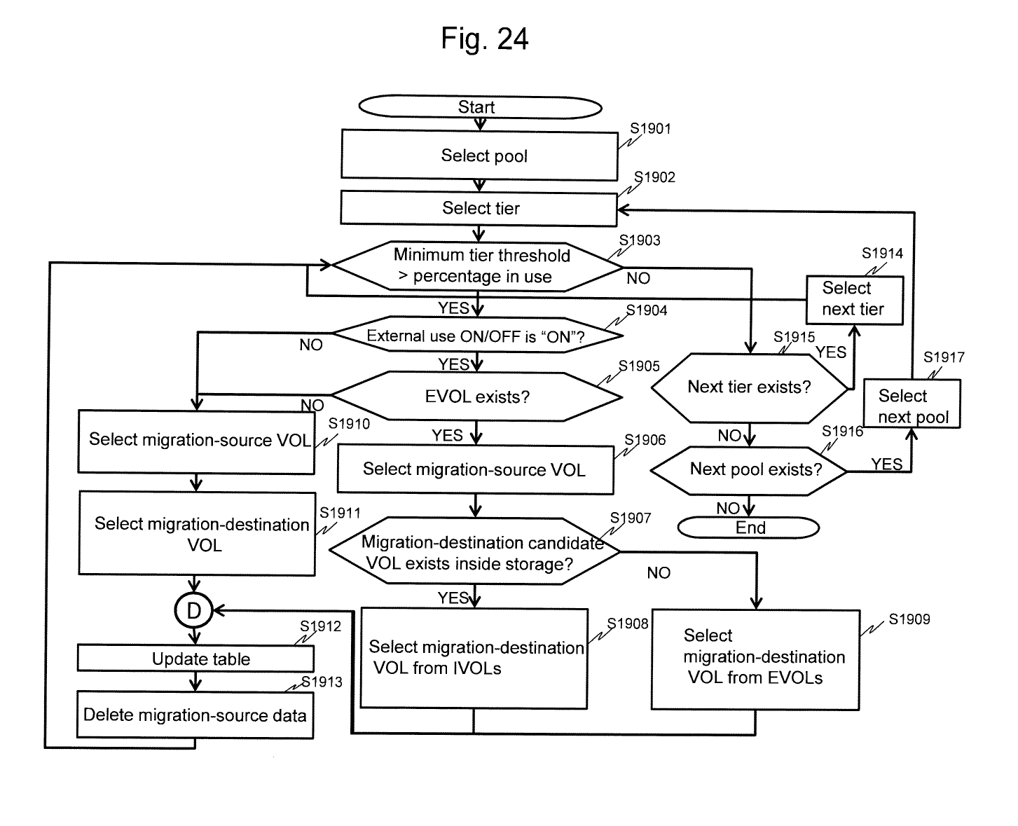

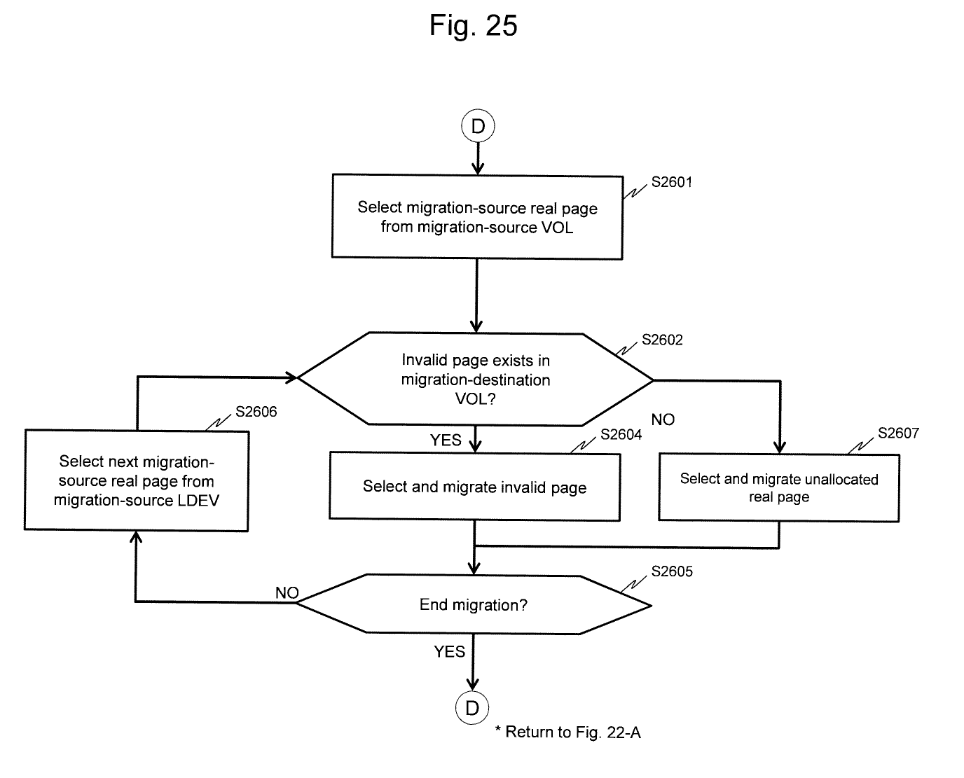

FIG. 24 is one part of an example of a flowchart of a pool capacity scale-down process of Example 3, and FIG. 25 is the remainder of this flowchart. This process is performed by the controller of the storage system 130, but may be performed by any other apparatus (for example, the host 110 or the management apparatus 120). For example, the management apparatus 120 or the host 110 may acquire information from the tables of the storage system 130 and the external storage 140, and, based on the acquired information, may perform the process.

In the following explanation, a process that is the same as that of the flowchart of the pool capacity scale-down process of Example 1 will be described using the same reference signs.

The processing of FIG. 25 (D in the drawing) is performed after a VOL with a free capacity in excess of the current used capacity of the migration-source VOL of the VOLs belonging to the same tier as the migration-source VOL in S1911 (or S1908, S1909) has been identified from either inside the storage system 130 or from the external storage 140. Subsequent to the processing of FIG. 25, the program moves to S1912.

In S2601, the program selects a real page from the migration-source VOL. Specifically, for example, the program makes the VOL identified in S1901 serve as the migration-source VOL, and selects the real page with the smallest ID from the migration-source VOL (hereinafter, this page will be called the migration-source real page). It is preferable that the migration-source real page be a valid page. That is, data migration is not performed for data stored in an invalid page.

In S2602, the program determines whether there is an invalid page in the migration-destination VOL. In a case where the result of the determination is that an invalid page exists in the migration-destination VOL (S2602: Yes), the program proceeds to S2603. Alternatively, in a case where an invalid page does not exist in the migration-destination VOL (S2602: No), the program moves to S2606.

In S2603, the program migrates data from the migration-source real page to the invalid page. In S2606, the program performs a data migration from the migration-source real page to an unallocated real page in the migration-destination VOL.

In S2604, the program determines whether or not the migration of the data of all the pages has been completed. In a case where the result of the determination is that the data migration has been completed (S2604: Yes), the program moves to S1912. Alternatively, in a case where the data migration has not been completed (S2604: No), the program proceeds to S2605.

In S2605, the program selects the real page with the next smallest ID from the migration-source VOL as the migration-source real page.

In the respective examples described above, when selecting a target in each process, first, targets with the smallest ID were selected in order, but the selection order is not limited to this. For example, targets may be selected in order from the largest ID, may be selected randomly, or may be selected in accordance with a different rule. The target referred to here is a pool, a Tier, a VOL, or a real page.

In the respective examples described above, one VOL is formed on the basis of one RAID group, but the present invention is not limited to this. Multiple VOLs may be formed with respect to one RAID group.

Furthermore, when updating the used capacity and used percentage of the pool management table, updating is done by taking into account the fact that data has been migrated to an invalid page. In other words, the used capacity and the used percentage of the pool management table become smaller than in a normal migration process. Consequently, by executing the relevant process, it is possible to enhance storage area utilization efficiency in the storage system.

What is claimed is:

1. A storage system, comprising:
multiple storage devices; and
a controller, which manages multiple internal volumes associated with the multiple storage devices, and multiple external volumes associated with multiple external storage devices included in an external storage, manages a first pool to which at least one internal volume included in the multiple internal volumes and at least one external volume included in the multiple external volumes are allocated, and, in accordance with receiving a write request, provides a first virtual volume to which one or more real pages inside the first pool are allocated,
wherein, in a case where a storage capacity of the first pool is to be reduced, the controller preferentially cancels the allocation to the first pool of an external volume included in the at least one external volume over the at least one internal volume.

2. A storage system according to claim 1, wherein the first pool comprises multiple tiers partitioned in accordance with performance,
the multiple tiers comprise a first tier, which is formed by a first internal volume included in the multiple internal volumes and a first external volume included in the multiple external volumes, and
in a case where a percentage of real pages allocated to the first virtual volume of multiple real pages included in the first tier is equal to or less than a threshold, the controller preferentially cancels the allocation to the first pool of the first external volume over the first internal volume.

3. A storage system according to claim 2, further comprising:
a memory for storing pool management information for managing the internal volume(s) and/or the external volume(s) allocated to each tier of the first pool,
wherein the controller references the pool management information, and preferentially cancels the allocation to the first pool of the first external volume over the first internal volume.

4. A storage system according to claim 3, wherein the first virtual volume comprises multiple virtual pages,
the controller, in accordance with a write request with respect to a virtual page in the first virtual volume, allocates a real page belonging to the first tier in the first pool to the virtual page,
the memory stores a virtual volume management table for managing an input/output load on a virtual page included in the first virtual volume, and
the controller references this virtual volume management table, migrates data in the real page to a real page in a different tier from the first tier in accordance with the input/output load on the virtual page, and allocates, instead of the real page, a real page in a different tier from the first tier to the virtual page.

5. A storage system according to claim 4, wherein the controller, upon referencing the pool management information and canceling the allocation to the first pool of the first external volume, migrates data in the first external volume to the first internal volume belonging to the first tier in which the first external volume is included.

6. A storage system according to claim 5, wherein the controller, upon migrating data inside the first external volume to the first internal volume, preferentially migrates data to a real page, which is in the first internal volume allocated to the first virtual volume, and in which is stored a specific data pattern.

7. A storage system according to claim 6, wherein in a case where the first external volume exists in plurality, the controller preferentially cancels the allocation to the first pool of, among the multiple first external volumes, an external volume in which the capacity of the real pages allocated to the first virtual volume is smallest.

8. A storage system according to claim 7, wherein in a case where the percentage of real pages allocated to the first virtual volume of the multiple real pages included in a first tier is equal to or larger than a threshold, and there exists an internal volume and an external volume which have a performance to be allocated to the first tier and which are not allocated to the first pool, the controller preferentially allocates, to the first tier, the internal volume not allocated to the first pool over the external volume not allocated to the first pool.

9. A storage system according to claim 8, wherein the controller additionally manages multiple pools comprising the first pool and a second pool, and, upon receiving a write request, provides a second virtual volume to which one or more real pages in the second pool are allocated,
external volume use information indicating whether or not an external volume can be allocated to a pool is stored in the memory for each pool, and
the controller configures the external volume use information such that, in a case where the second pool capacity is to be scaled up, an external volume cannot be allocated to the second pool even when the external volume has not been allocated to the first pool and the second pool.

10. A storage system according to claim 9, wherein the multiple storage devices comprise storage devices with different performance.

11. A control method in a storage system which comprises multiple storage devices, the control method comprising the steps of:
managing multiple internal volumes associated with the multiple storage devices, and multiple external volumes associated with multiple external storage devices included in an external storage;
managing a first pool to which at least one internal volume included in the multiple internal volumes and at least one external volume included in the multiple external volumes are allocated;
providing a first virtual volume to which one or more real pages inside the first pool are allocated in accordance with receiving a write request; and
preferentially canceling the allocation to the first pool of an external volume included in the at least one external volume over the at least one internal volume in a case where a storage capacity of the first pool is to be reduced.

12. A control method according to claim 11, wherein the first pool comprises multiple tiers partitioned in accordance with performance, and the multiple tiers comprise a first tier, which is formed by a first internal volume included in the multiple internal volumes and a first external volume included in the multiple external volumes,
wherein in a case where a percentage of real pages allocated to the first virtual volume of multiple real pages included in the first tier is equal to or less than a threshold, the allocation to the first pool of the first external volume is preferentially canceled over the first internal volume.

13. A control method according to claim 12, wherein when the allocation to the first pool of the first external volume is canceled, data in the first external volume is migrated to the first internal volume belonging to the first tier in which the first external volume is included.

14. A control method according to claim 13, wherein when data inside the first external volume is migrated to the first internal volume, data is preferentially migrated to a real page which is in the first internal volume allocated to the first virtual volume, and in which is stored a specific data pattern.

15. A control method according to claim 14, wherein in a case where the first external volume exists in plurality, the allocation to the first pool of, among the multiple first external volumes, an external volume in which the capacity of the real pages allocated to the first virtual volume is smallest is preferentially canceled.
